(19) United States
(12) Patent Application Publication
(10) Pub. No.: US 2026/0252650 A1
(43) Pub. Date: Aug. 27, 2026

(54) SYSTEM

(71) Applicant: SoftBank Group Corp., Tokyo (JP)

(72) Inventor: Haruka OGAWA, Tokyo (JP)

(73) Assignee: SoftBank Group Corp., Tokyo (JP)

(21) Appl. No.: 19/537,550

(22) Filed: Feb. 12, 2026

(30) Foreign Application Priority Data
Feb. 21, 2025 (JP) 2025-027042

(51) Int. Cl. G06F 16/9535; G06N 3/045; G06N 3/084

(52) U.S. Cl. CPC G06F 16/9535; G06N 3/045; G06N 3/084

(57) ABSTRACT

The system according to the embodiment comprises a collection unit, an analysis unit, and a proposal unit. The collection unit collects data. The analysis unit analyzes the data collected by the collection unit. The proposal unit proposes applications and business models based on an analysis result obtained by the analysis unit.

### CROSS-REFERENCE TO RELATED APPLICATION

The present application claims priority to and incorporates by reference the entire contents of Japanese Patent Application No. 2025-027042 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, proposals for effective utilization methods and business models for land and property have not been sufficiently made, and there is room for improvement.

### SUMMARY OF THE INVENTION

The system according to the embodiment comprises a collection unit, an analysis unit, and a proposal unit. The collection unit collects data. The analysis unit analyzes the data collected by the collection unit. The proposal unit proposes applications and business models based on an analysis result obtained by the analysis unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi®, or Bluetooth®, among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

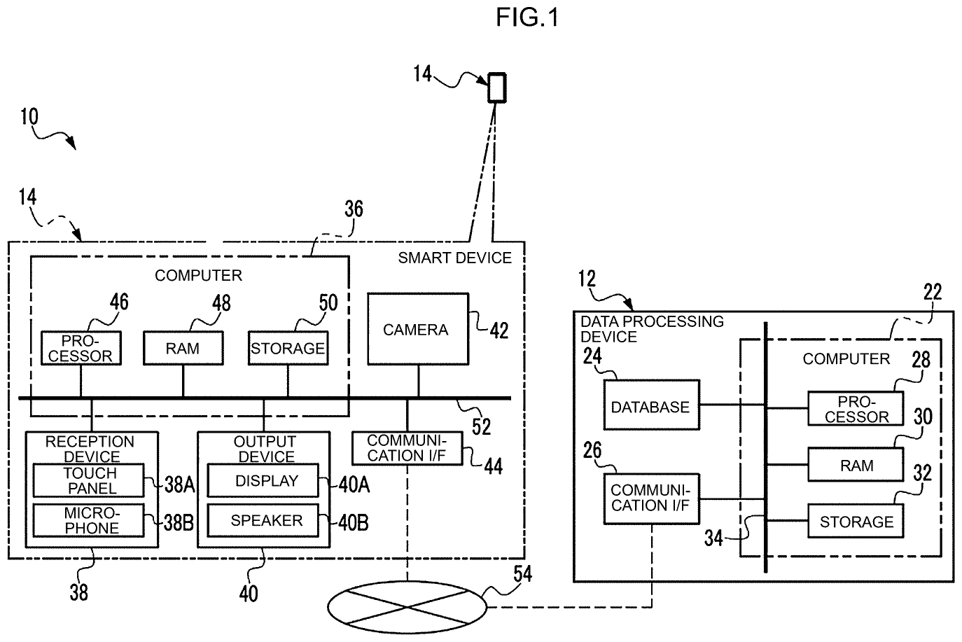

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

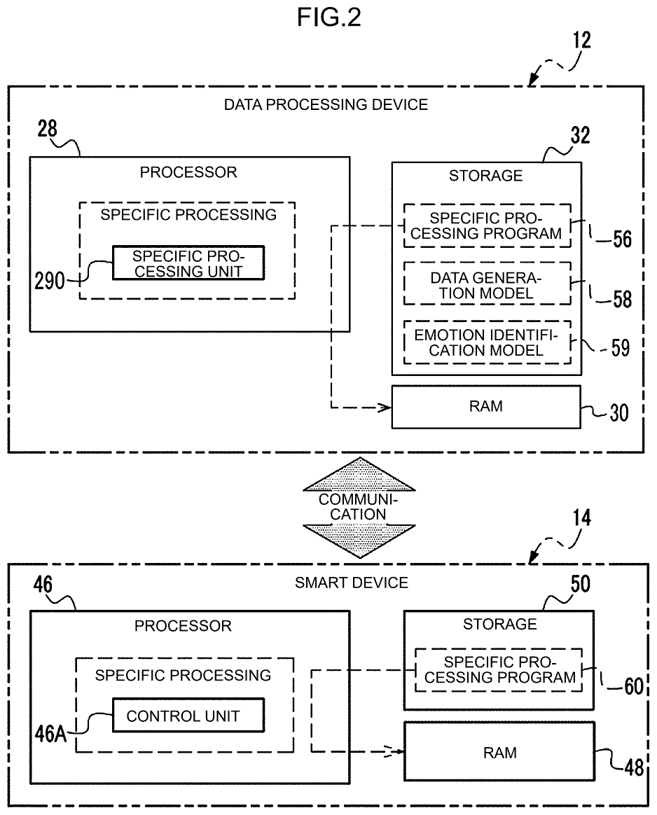

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system that proposes effective utilization methods and business models for land or property in conjunction with the sale and purchase of such land or property. This system collects data such as local trends, age and gender of residents, surrounding stores, purchase and payment information, customer unit price, and trains AI with this data to propose optimal applications and business models for the land or property. For example, data on local trends and resident attributes can be collected from SNS posts and survey results. From SNS post content and survey results, it is possible to grasp products and services trending in the region, as well as the age and gender distribution of residents. In addition, data on surrounding stores, purchase and payment information, and customer unit price can be collected from electronic payment systems and POS systems. From electronic payment system data, it is possible to determine which products are purchased at which stores and the level of customer unit price. Next, the collected data is used to train AI. The AI analyzes these data to grasp local characteristics and resident needs. For example, by analyzing local trends, resident attributes, and purchase/payment information, the AI can identify popular products and services and resident needs in the region. Furthermore, based on the analysis result, the AI proposes optimal applications and business models for the land or property. For example, if the AI determines from the analyzed data that cafes are popular in the region, it can propose opening a cafe. In areas with a high proportion of elderly residents, it can propose opening services or facilities for the elderly. In this way, the AI proposes optimal applications and business models for the land or property. Based on these proposals, effective utilization of the land or property is achieved. For example, opening a cafe as proposed by the AI enables effective use of the land or property. Also, opening services or facilities for the elderly increases the number of facilities available to elderly residents and contributes to regional revitalization. With this mechanism, the system can propose effective utilization methods and business models for land or property in conjunction with their sale and purchase. As a result, effective utilization of land or property is achieved, contributing to regional revitalization. For example, based on the business model proposed by the AI, new stores or facilities may be opened, revitalizing the local economy and enriching the lives of residents. Thus, the system enables effective utilization of land or property and contributes to regional revitalization. Specifically, the system comprises multiple data collection modules, a data preprocessing module, a feature extraction module, an AI analysis module, an application/business model proposal module, a feedback collection module, and a proposal result management module. The data collection module of the system automatically collects data from various data sources, such as SNS post data (e.g., post text of 256-1024 tokens, image data, post time, poster attributes), survey response data (e.g., age, gender, occupation, interest selection responses), purchase history data from electronic payment systems (e.g., store ID, product category, purchase amount, payment time), and sales data from POS systems (e.g., product ID, sales quantity, unit price, sales time). The data preprocessing module performs missing value imputation, outlier removal, one-hot encoding of categorical variables, tokenization of text data, resizing and normalization of image data, and generates input tensors for the AI analysis module (e.g., N×D dimensional numerical matrices, N posts×D-dimensional feature vectors). The AI analysis module is composed of a combination of multiple AI models, such as Transformer-based large language models, convolutional neural networks (CNN), and gradient boosting decision trees (GBDT). The AI analysis module performs extraction of local trend words from SNS post text, resident clustering from survey data, purchase pattern extraction from purchase history, and commercial area analysis. Examples of AI input include (1) “SNS post text: ‘Recently, a new cafe is trending in this area’, poster age: 28, gender: female, post time: 2024-05-01 12:34” and (2) “Purchase history: store ID=12345, product category=cafe, purchase amount=800 yen, payment time=2024-05-02 10:15”. Examples of AI output include (1) “Local trend score: cafe=0.85, bakery=0.40, fitness=0.20” (score is a probability value from 0 to 1), and (2) “Resident cluster: elderly ratio=0.65, young ratio=0.20”. The AI analysis module passes these outputs to the application/business model proposal module. The application/business model proposal module takes the AI analysis result as input and uses rule-based decision trees or reinforcement learning algorithms to propose optimal applications (e.g., cafe, shared office, day service for the elderly, etc.) and business models (e.g., subscription-type cafe, community-based retail, health-oriented restaurant, etc.) for each land or property. The output format of the proposal is structured data such as application label, recommendation reason, expected revenue prediction value, and local needs fit score. For example, “Application: cafe, recommendation reason: high local trend score, expected revenue: 500,000 yen/month, fit: 0.92” may be output. Subsequently, the proposed content is recorded in the proposal result management module and presented to users and real estate operators in dashboard or report format. Furthermore, the feedback collection module collects actual sales data after opening and user survey results, which are used for retraining the AI model and optimizing the parameters of the proposal algorithm. As a result, the system achieves a technical effect of greatly improving the accuracy and speed of proposals for effective utilization of land and property by rapidly and accurately analyzing vast multidimensional data and extracting complex local characteristics and latent needs that were previously difficult for humans to grasp, rather than merely automating human decision-making. Specific application fields include urban redevelopment, real estate investment decision-making, regional revitalization projects, new commercial facility opening plans, measures against vacant houses, and planning of regional revitalization policies.

The system according to the embodiment comprises a collection unit, an analysis unit, and a proposal unit. The collection unit collects data. The data may include, for example, local trends, age and gender of residents, surrounding stores, purchase and payment information, customer unit price, and the like, but is not limited to such examples. The collection unit, for example, grasps products and services trending in the region and the age and gender distribution of residents from SNS post content and survey results. The collection unit can also determine which products are purchased at which stores and the level of customer unit price from electronic payment systems and POS systems. The analysis unit analyzes the data collected by the collection unit using AI. The AI, for example, uses technologies such as deep learning and natural language processing to grasp local characteristics and resident needs. For example, the AI analyzes local trends, resident attributes, and purchase/payment information to identify popular products and services and resident needs in the region. The proposal unit proposes optimal applications and business models based on the analysis result obtained by the analysis unit. For example, if the AI determines from the analyzed data that cafes are popular in the region, the proposal unit can propose opening a cafe. In areas with a high proportion of elderly residents, it can also propose opening services or facilities for the elderly. Thus, the system enables effective utilization of land or property and contributes to regional revitalization. Some or all of the above-described processing in the proposal unit may be performed using AI or without using AI. For example, the proposal unit may use an AI model that takes the analysis result obtained by the analysis unit as input and outputs optimal applications and business models to make proposals. Furthermore, the proposal unit may include a support unit that assists in the execution of the proposed business model. The support unit may, for example, assist in the execution of the proposed business model by means such as financial assistance or technical support. The proposal unit may also include a feedback unit that collects feedback on the proposed content. The feedback unit may, for example, collect feedback on the proposed content by means such as surveys or user reviews. As a result, the accuracy of proposals is improved, enabling more appropriate proposals. Specifically, the system comprises, as the collection unit, multiple data collection modules (SNS API integration module, automatic survey distribution module, electronic payment data acquisition module, POS data integration module, etc.), each of which automatically acquires data in JSON or CSV format and stores it in a database. The analysis unit of the system is composed of a combination of multiple AI models, such as Transformer-based large language models, convolutional neural networks, and gradient boosting decision trees. The analysis unit receives SNS post text (e.g., up to 1024 tokens of text, poster attribute vector, post time), survey responses (e.g., category values for age, gender, occupation, interests), purchase history (e.g., store ID, product category, purchase amount, payment time), etc. as input tensors, and performs preprocessing such as missing value imputation, one-hot encoding of categorical variables, tokenization of text, and resizing/normalization of image data. The AI models perform extraction of local trend words from SNS posts, resident clustering from survey data, purchase pattern extraction from purchase history, and commercial area analysis. Examples of AI input include “SNS post text: ‘A new bakery is trending in this area’, poster age: 35, gender: male, post time: 2024-05-10 09:00” and “Purchase history: store ID=54321, product category=bakery, purchase amount=600 yen, payment time=2024-05-11 14:20”. Examples of AI output include “Local trend score: bakery=0.78, cafe=0.65, fitness=0.30” (score is a probability value from 0 to 1) and “Resident cluster: elderly ratio=0.55, young ratio=0.30”. The proposal unit takes the AI analysis result as input and uses rule-based decision trees or reinforcement learning algorithms to propose optimal applications (e.g., cafe, shared office, day service for the elderly, etc.) and business models (e.g., subscription-type cafe, community-based retail, health-oriented restaurant, etc.) for each land or property. The output format of the proposal is structured data such as application label, recommendation reason, expected revenue prediction value, and local needs fit score, and for example, “Application: bakery, recommendation reason: high local trend score, expected revenue: 400,000 yen/month, fit: 0.88” may be output. Subsequently, the proposed content is recorded in the proposal result management module and presented to users and real estate operators in dashboard or report format. The support unit automatically selects and presents to users the financial assistance (e.g., loan candidate list, grant information) and technical support (e.g., store operation know-how, IT system introduction support) necessary for the execution of the proposed business model. The feedback unit collects actual sales data after opening and user survey results, which are used for retraining the AI model and optimizing the parameters of the proposal algorithm. As a result, the system achieves a technical effect of greatly improving the accuracy and speed of proposals for effective utilization of land and property by rapidly and accurately analyzing vast multidimensional data and extracting complex local characteristics and latent needs that were previously difficult for humans to grasp, rather than merely automating human decision-making. Specific application fields include urban redevelopment, real estate investment decision-making, regional revitalization projects, new commercial facility opening plans, measures against vacant houses, and planning of regional revitalization policies.

The collection unit can collect data including local trends, age and gender of residents, surrounding stores, purchase and payment information, customer unit price, and other data. Local trends may include, for example, social media trends and event information, but are not limited to such examples. The collection unit, for example, analyzes social media post content to identify products and services trending in the region. The collection unit can also conduct surveys to grasp the age and gender distribution of residents. Surrounding stores may include, for example, store types and location information, but are not limited to such examples. The collection unit, for example, determines which products are purchased at which stores from electronic payment systems and POS systems. Purchase and payment information may include, for example, POS data and online payment data, but is not limited to such examples. The collection unit, for example, determines the level of customer unit price from electronic payment system data. By collecting data on local trends and resident attributes, more accurate analysis becomes possible. Some or all of the above-described processing in the collection unit may be performed using AI or without using AI. For example, the collection unit may input social media post content to AI and have the AI perform analysis to identify local trends. Specifically, the collection unit comprises multiple data collection modules (SNS API integration module, automatic survey distribution module, electronic payment data acquisition module, POS data integration module, etc.), each of which automatically acquires data in JSON or CSV format and stores it in a database. The collection unit automatically collects data from various data sources, such as SNS post data (e.g., post text of 256-1024 tokens, image data, post time, poster attributes), survey response data (e.g., age, gender, occupation, interest selection responses), purchase history data from electronic payment systems (e.g., store ID, product category, purchase amount, payment time), and sales data from POS systems (e.g., product ID, sales quantity, unit price, sales time). The collection unit works with the data preprocessing module to perform missing value imputation, outlier removal, one-hot encoding of categorical variables, tokenization of text data, resizing and normalization of image data, and generates input tensors for the AI analysis module (e.g., N×D dimensional numerical matrices, N posts×D-dimensional feature vectors). When using AI, the collection unit, for example, converts SNS post text such as “Recently, a new cafe is trending in this area”, poster age 28, gender female, post time 2024-05-01 12:34 into input tensors and passes them to the AI analysis module. The AI analysis module is composed of a combination of multiple AI models, such as Transformer-based large language models, convolutional neural networks, and gradient boosting decision trees, and performs extraction of local trend words from SNS post text, resident clustering from survey data, purchase pattern extraction from purchase history, and commercial area analysis. Examples of AI output include “Local trend score: cafe=0.85, bakery=0.40, fitness=0.20” (score is a probability value from 0 to 1) and “Resident cluster: elderly ratio=0.65, young ratio=0.20”. These outputs are passed to the subsequent application/business model proposal module and used to propose optimal applications and business models for each land or property. Conventional human data collection made it difficult to collect vast multidimensional data in real time and extract high-dimensional features, but the collection unit achieves a technical effect of greatly improving the accuracy, speed, and coverage of data collection through automation and optimization using AI. Specific application fields include urban redevelopment, real estate investment decision-making, regional revitalization projects, new commercial facility opening plans, measures against vacant houses, and planning of regional revitalization policies.

The analysis unit analyzes the collected data using AI to grasp local characteristics and resident needs. The AI, for example, uses technologies such as deep learning and natural language processing to grasp local characteristics and resident needs. For example, the AI analyzes local trends, resident attributes, and purchase/payment information to identify popular products and services and resident needs in the region. Deep learning learns from large amounts of data and has advanced pattern recognition capabilities. Natural language processing is a technology for analyzing text data and understanding its meaning. The AI combines these technologies to grasp local characteristics and resident needs. For example, the AI analyzes social media post content to identify products and services trending in the region. The AI can also analyze survey results to grasp the age and gender distribution of residents. Furthermore, the AI analyzes data from electronic payment systems and POS systems to determine which products are purchased at which stores and the level of customer unit price. By grasping local characteristics and resident needs, more appropriate proposals become possible. Some or all of the above-described processing in the analysis unit may be performed using AI or without using AI. For example, the analysis unit may input the collected data to AI and have the AI perform analysis to grasp local characteristics and resident needs. Specifically, the analysis unit is composed of a combination of multiple AI models, such as Transformer-based large language models, convolutional neural networks, and gradient boosting decision trees. The analysis unit receives SNS post text (e.g., up to 1024 tokens of text, poster attribute vector, post time), survey responses (e.g., category values for age, gender, occupation, interests), purchase history (e.g., store ID, product category, purchase amount, payment time), etc. as input tensors, and performs preprocessing such as missing value imputation, one-hot encoding of categorical variables, tokenization of text, and resizing/normalization of image data. The AI models perform extraction of local trend words from SNS posts, resident clustering from survey data, purchase pattern extraction from purchase history, and commercial area analysis. Examples of AI input include “SNS post text: ‘A new bakery is trending in this area’, poster age: 35, gender: male, post time: 2024-05-10 09:00” and “Purchase history: store ID=54321, product category=bakery, purchase amount=600 yen, payment time=2024-05-11 14:20”. Examples of AI output include “Local trend score: bakery=0.78, cafe=0.65, fitness=0.30” (score is a probability value from 0 to 1) and “Resident cluster: elderly ratio=0.55, young ratio=0.30”. The AI analysis module passes these outputs to the application/business model proposal module, which uses rule-based decision trees or reinforcement learning algorithms for application/business model proposals. Internally, the AI model uses, for example, the Transformer architecture to extract important words from post text using self-attention mechanisms, CNN to extract store appearance features from image data, and GBDT to classify purchase patterns from numerical data. During training, weights are optimized using cross-entropy loss or mean squared error, and data augmentation is performed by generating text paraphrases or random cropping of images. The analysis unit achieves a technical effect of enabling integrated analysis of multidimensional data and extraction of high-dimensional features, which were difficult with conventional human analysis, thereby greatly improving analysis accuracy, speed, and coverage. Specific application fields include urban redevelopment, real estate investment decision-making, regional revitalization projects, new commercial facility opening plans, measures against vacant houses, and planning of regional revitalization policies.

The proposal unit can propose applications and business models for the land or property based on the analysis result. For example, if the AI determines from the analyzed data that cafes are popular in the region, the proposal unit can propose opening a cafe. In areas with a high proportion of elderly residents, it can also propose opening services or facilities for the elderly. The AI proposes optimal applications and business models based on the analysis result. For example, the AI analyzes local trends, resident attributes, and purchase/payment information to identify popular products and services and resident needs in the region. Thus, by proposing optimal applications and business models based on the analysis result, the proposal unit enables effective utilization of land or property. Some or all of the above-described processing in the proposal unit may be performed using AI or without using AI. For example, the proposal unit may use an AI model that takes the analysis result obtained by the analysis unit as input and outputs optimal applications and business models to make proposals. Furthermore, the proposal unit may include a support unit that assists in the execution of the proposed business model. The support unit may, for example, assist in the execution of the proposed business model by means such as financial assistance or technical support. The proposal unit may also include a feedback unit that collects feedback on the proposed content. The feedback unit may, for example, collect feedback on the proposed content by means such as surveys or user reviews. As a result, the accuracy of proposals is improved, enabling more appropriate proposals. Specifically, the proposal unit takes the AI analysis result as input and uses rule-based decision trees or reinforcement learning algorithms to propose optimal applications (e.g., cafe, shared office, day service for the elderly, etc.) and business models (e.g., subscription-type cafe, community-based retail, health-oriented restaurant, etc.) for each land or property. The output format of the proposal is structured data such as application label, recommendation reason, expected revenue prediction value, and local needs fit score, and for example, “Application: cafe, recommendation reason: high local trend score, expected revenue: 500,000 yen/month, fit: 0.92” may be output. Internally, the AI model takes the analysis result as input, scores each application/business model candidate, and selects the optimal proposal by threshold judgment or ranking. Subsequently, the proposed content is recorded in the proposal result management module and presented to users and real estate operators in dashboard or report format. The support unit automatically selects and presents to users the financial assistance (e.g., loan candidate list, grant information) and technical support (e.g., store operation know-how, IT system introduction support) necessary for the execution of the proposed business model. The feedback unit collects actual sales data after opening and user survey results, which are used for retraining the AI model and optimizing the parameters of the proposal algorithm. The proposal unit achieves a technical effect of enabling integrated decision-making of multidimensional data and reflection of complex local characteristics, which were difficult with conventional human proposals, thereby greatly improving proposal accuracy, speed, and feasibility. Specific application fields include urban redevelopment, real estate investment decision-making, regional revitalization projects, new commercial facility opening plans, measures against vacant houses, and planning of regional revitalization policies.

The proposal unit may include a support unit configured to assist in the execution of the proposed business model. The support unit may, for example, assist in the execution of the proposed business model by means such as financial assistance or technical support. Financial assistance may include, for example, provision of loans or grants, but is not limited to such examples. Technical support may include, for example, provision of technical advice or training, but is not limited to such examples. By assisting in the execution of the proposed business model, the support unit improves the feasibility of the proposal. Some or all of the above-described processing in the support unit may be performed using AI or without using AI. For example, the support unit may have AI select the optimal method for assisting in the execution of the proposed business model. Thus, by assisting in the execution of the proposed business model, the support unit improves the feasibility of the proposal. Specifically, the support unit receives application/business model proposal data (e.g., application label, recommendation reason, expected revenue, fit score, etc.) from the proposal unit as input and works with external resource databases such as financial assistance candidates (e.g., loan product lists from financial institutions, grant information from local governments) and technical support candidates (e.g., store operation manuals, IT system introduction support services). The support unit uses AI models (e.g., gradient boosting decision trees or rule-based recommendation engines) to input proposal content, user attributes, local characteristics, market environment, etc. as features and score/rank the optimal support means for selection. Examples of AI input include “Application: cafe, region: urban area, user attribute: female in her 30s, expected revenue: 500,000 yen/month”, and examples of AI output include “Financial assistance candidate: Bank A loan product, Grant B; Technical support candidate: cafe operation manual, POS system introduction support”. Subsequently, the selected support means are presented to the user in dashboard or report format, and the user can select and apply for the support content. The support unit links the user's selection history and actual support usage results to the feedback unit, which are used for retraining the AI model and optimizing the support algorithm. Conventional human selection of support means made it difficult to comprehensively search vast external resources and optimally match user attributes and local characteristics, but the support unit achieves a technical effect of greatly improving the accuracy, speed, and coverage of support means selection through automation and optimization using AI. Specific application fields include startup support, business restructuring, regional revitalization projects, support for new commercial facility openings, support for utilization of vacant houses, and support for implementation of regional revitalization policies.

The proposal unit may include a feedback unit configured to collect feedback on the proposed content. The feedback unit may, for example, collect feedback on the proposed content by means such as surveys or user reviews. Surveys may include, for example, online surveys or telephone interviews, but are not limited to such examples. User reviews may include, for example, review posts on websites or applications, but are not limited to such examples. By collecting feedback on the proposed content, the feedback unit improves the accuracy of proposals, enabling more appropriate proposals. Some or all of the above-described processing in the feedback unit may be performed using AI or without using AI. For example, the feedback unit may input the collected feedback data to AI and have the AI analyze improvement points for the proposed content. Thus, by collecting feedback on the proposed content, the feedback unit improves the accuracy of proposals, enabling more appropriate proposals. Specifically, the feedback unit automatically collects user survey response data (e.g., satisfaction score for the proposed content, free-text comments, requests for improvement), review post data on websites or applications (e.g., star rating, text review, post time, user attributes), and the like. The feedback unit uses AI models (e.g., natural language processing models and clustering algorithms) to convert the collected feedback data into input tensors and perform keyword extraction by text mining, sentiment analysis, satisfaction clustering, and automatic classification of requests for improvement. Examples of AI input include “Review: ‘The proposed cafe model matched local needs, but the revenue forecast was excessive’, star rating: 3, post time: 2024-06-01 15:20” and “Survey response: satisfaction=4, request for improvement=‘Increase proposals for services for the elderly’”. Examples of AI output include “Satisfaction cluster: high rating group=0.70, low rating group=0.30” and “Request for improvement keywords: revenue forecast, elderly services”. Subsequently, the AI analysis result is fed back to the proposal unit and support unit and used for parameter optimization and retraining of the application/business model proposal algorithm and support means selection algorithm. Conventional human feedback analysis made it difficult to integrate and analyze vast free-text data and diverse evaluation indicators, but the feedback unit achieves a technical effect of greatly improving the accuracy, speed, and coverage of feedback collection and analysis through automation and optimization using AI. Specific application fields include urban redevelopment, real estate investment decision-making, regional revitalization projects, new commercial facility opening plans, measures against vacant houses, and planning of regional revitalization policies.

The collection unit can estimate a user's emotion and adjust the timing of data collection based on the estimated emotion of the user. For example, if the user is excited, the collection unit collects data in real time and performs immediate analysis. If the user is relaxed, the collection unit may collect data periodically and reduce the frequency of analysis. Furthermore, if the user is stressed, the collection unit may reduce the frequency of data collection to alleviate the user's burden. By adjusting the timing of data collection according to the user's emotion, more appropriate data collection becomes possible. Emotion estimation is realized, for example, by using an emotion engine or generative AI with emotion estimation functionality. Generative AI may include text generation AI (e.g., LLM) or multimodal generative AI, but is not limited to such examples. Some or all of the above-described processing in the collection unit may be performed using AI or without using AI. For example, the collection unit may input the user's facial expression data to generative AI and have the generative AI perform emotion estimation. Specifically, the collection unit simultaneously acquires multiple modalities for user emotion estimation, such as facial image data (e.g., 128×128 pixel RGB images), audio waveform data (e.g., 3 seconds of 16 kHz sampled audio), and text data (e.g., user utterances or chat content, up to 512 tokens), and inputs these to a multimodal AI model. For image input, a convolutional neural network (CNN) is used; for audio input, a recurrent neural network (RNN) or Transformer with self-attention mechanism is used; for text input, a large language model is used. The outputs of these feature extraction layers are integrated, and a fully connected layer outputs emotion labels (e.g., excitement, relaxation, stress, indifference, etc.) and emotion intensity scores (e.g., continuous values from 0.0 to 1.0). Examples of AI input include (1) “Facial image: smiling, audio: high pitch, text: ‘I'm really looking forward to it!’” and (2) “Facial image: expressionless, audio: low pitch, text: ‘It's so-so.’”. Examples of AI output include (1) “Emotion label: excitement, intensity: 0.92” and (2) “Emotion label: relaxation, intensity: 0.45”. The collection unit sends signals based on these emotion estimation results to the data collection timing control module, which dynamically schedules real-time collection, periodic collection, or reduced collection frequency. Subsequently, the collection timing control result is recorded in the database and also affects the processing flow of the analysis unit and proposal unit. For AI model training, a large-scale multimodal dataset with emotion labels is used, and weights are optimized using cross-entropy loss or mean squared error. The collection unit achieves a technical effect of enabling real-time and highly accurate emotion-adaptive data collection, which was difficult with conventional human emotion observation and manual scheduling, thereby improving user experience, optimizing data quality, and enhancing overall system efficiency. Specific application fields include resident behavior monitoring in smart cities, well-being support services, personalized marketing, optimization of real estate viewing experiences, and stress detection-type data collection in medical and nursing care settings.

The collection unit can analyze past data collection history and select an optimal collection method. For example, the collection unit identifies the most effective collection timing from past data collection history and collects data at that timing. The collection unit can also select the optimal data collection means (survey, SNS analysis, etc.) based on past data collection history. Furthermore, the collection unit can analyze past data collection history and propose collection methods to improve data quality. By analyzing past data collection history, the optimal collection method can be selected. Some or all of the above-described processing in the collection unit may be performed using AI or without using AI. For example, the collection unit may input past data collection history to AI and have the AI perform analysis to select the optimal collection method. Specifically, the collection unit records past data collection history in a time-series database, including collection date and time, collection means (e.g., survey, SNS API, POS integration), collection target attributes (e.g., age group, region, gender), number of collected data, missing rate of collected data, and post-collection analysis accuracy (e.g., AI model F1 score or RMSE). For AI models, long short-term memory networks (LSTM) or gradient boosting decision trees (GBDT) are used for time-series analysis, random forest for feature selection, and reinforcement learning algorithms (e.g., bandit algorithms) for optimizing collection means. Examples of AI input include (1) “Collection date and time: 2024-05-01 10:00, means: survey, target: women in their 30s, number: 100, missing rate: 0.05, analysis accuracy: 0.82” and (2) “Collection date and time: 2024-05-02 15:00, means: SNS API, target: men in their 20s, number: 200, missing rate: 0.10, analysis accuracy: 0.88”. Examples of AI output include (1) “Recommended collection timing: weekday 18:00, recommended means: SNS API, expected accuracy: 0.90” and (2) “Recommended collection means: survey, recommended target: men in their 40s, expected number: 150”. The collection unit controls the collection scheduler and means selection module based on the AI output results to automatically collect data at the optimal timing, means, and target attributes. Subsequently, the collection results are recorded in the database and contribute to improving the accuracy of the analysis unit and proposal unit. For AI model training, the relationship between past collection history and analysis accuracy is used as training data, and loss functions such as maximizing collection efficiency and analysis accuracy are used. The collection unit achieves a technical effect of enabling optimization of large-scale, multidimensional data collection, which was difficult with conventional human heuristics and manual optimization, thereby improving data quality, reducing collection costs, and maximizing analysis accuracy. Specific application fields include automatic optimization of urban data platforms, personalized marketing, medical and health data collection, optimization of IoT sensor network operation, and efficiency improvement of social surveys.

The collection unit can filter collection targets at the time of data collection based on local events and seasonal variations. For example, the collection unit prioritizes the collection of relevant data during event periods based on local event information. The collection unit can also set different data collection items for each season according to seasonal variations. Furthermore, the collection unit can filter data related to specific local events or seasons and narrow down collection targets. By filtering collection targets based on local events and seasonal variations, more relevant data can be collected. Some or all of the above-described processing in the collection unit may be performed using AI or without using AI. For example, the collection unit may input local event information to AI and have the AI perform analysis to filter relevant data. Specifically, the collection unit works with external databases such as local event calendars (e.g., event name, date and time, location, organizer, expected number of visitors) and seasonal information (e.g., spring, summer, autumn, winter, temperature, holidays, school vacation periods), and tags collection target data (e.g., SNS posts, purchase history, survey responses) with event/season tags. For AI models, decision tree models are used for event/season feature input, LSTM for event time-series pattern extraction, and Transformer-based multivariate classification models for relevance scoring. Examples of AI input include (1) “Event: summer festival, date: 2024-08-10, location: Central Park, SNS post: ‘The festival is bustling today’, post time: 2024-08-10 18:00” and (2) “Season: winter, purchase history: product category=hot pot, purchase amount=1,200 yen, payment time=2024-12-15 19:30”. Examples of AI output include (1) “Collection priority: summer festival-related data=0.95, regular data=0.40” and (2) “Filtering result: only winter-limited product data collected”. The collection unit controls the collection target selection module based on the AI output results to automate data collection according to events and seasons. Subsequently, the filtered data is passed to the analysis unit and used for event effect analysis and seasonal variation analysis. For AI model training, the relationship between event/season-tagged data and improved analysis accuracy is used as training data, and relevance score maximization is used as the loss function. The collection unit achieves a technical effect of enabling event/season-adaptive data collection, which was difficult with conventional human manual filtering and heuristics, thereby improving data relevance, analysis accuracy, and operational efficiency. Specific application fields include tourism demand forecasting, seasonal product marketing, measurement of local event effects, urban event operation support, and weather variation-adaptive data collection.

The collection unit can estimate a user's emotion and determine the priority of data to be collected based on the estimated emotion of the user. For example, if the user is excited, the collection unit prioritizes the collection of important data in real time. If the user is relaxed, the collection unit may adjust the priority of data collected periodically. Furthermore, if the user is stressed, the collection unit may reduce the amount of data collected and prioritize only important data. By determining the priority of data to be collected according to the user's emotion, important data can be collected preferentially. Emotion estimation is realized, for example, by using an emotion engine or generative AI with emotion estimation functionality. Generative AI may include text generation AI (e.g., LLM) or multimodal generative AI, but is not limited to such examples. Some or all of the above-described processing in the collection unit may be performed using AI or without using AI. For example, the collection unit may input the user's facial expression data to generative AI and have the generative AI perform emotion estimation. Specifically, the collection unit simultaneously acquires facial image data (e.g., 128×128 pixel RGB images), audio data (e.g., 2 seconds of 16 kHz sampled audio), and text data (e.g., chat utterances, up to 256 tokens) for user emotion estimation and inputs them to a multimodal AI model. For image input, CNN is used; for audio input, RNN or Transformer is used; for text input, a large language model is used; and the features are integrated to output emotion labels (e.g., excitement, relaxation, stress) and emotion intensity scores (0.0-1.0). Examples of AI input include (1) “Facial image: smiling, audio: high pitch, text: ‘I'm really looking forward to it!’” and (2) “Facial image: frowning, audio: low pitch, text: ‘I'm tired today.’”. Examples of AI output include (1) “Emotion label: excitement, intensity: 0.90” and (2) “Emotion label: stress, intensity: 0.75”. The collection unit assigns priority scores to each data item based on the AI emotion estimation results and collects data in order of priority, such as purchase history, location information, SNS posts, etc. Subsequently, the priority scores are recorded in the database and reflected in the processing flow of the analysis unit and proposal unit. For AI model training, a multimodal dataset with emotion labels is used, and weights are optimized using cross-entropy loss. The collection unit achieves a technical effect of enabling real-time and highly accurate emotion-adaptive data priority control, which was difficult with conventional human emotion observation and manual priority setting, thereby improving the efficiency of important data collection, minimizing user burden, and optimizing the entire system. Specific application fields include personalized healthcare, stress detection-type data collection, smart home behavior monitoring, emotion-adaptive marketing, and optimization of real estate viewing experiences.

The collection unit can preferentially collect highly relevant data at the time of data collection by considering the geographic location information of the region. For example, the collection unit prioritizes the collection of data from specific areas based on geographic location information. The collection unit can also filter highly relevant data by considering geographic location information and narrow down collection targets. Furthermore, the collection unit can prioritize the collection of purchase and payment information in specific areas based on geographic location information. By preferentially collecting highly relevant data by considering geographic location information, more accurate data collection becomes possible. Some or all of the above-described processing in the collection unit may be performed using AI or without using AI. For example, the collection unit may input geographic location information to AI and have the AI perform analysis to filter highly relevant data. Specifically, the collection unit acquires GPS coordinates (e.g., latitude and longitude), area ID (e.g., municipality code), location accuracy (e.g., ±10 m), and collection target data (e.g., SNS posts, purchase history, survey responses), and assigns geographic features. For AI models, k-means or DBSCAN is used for spatial clustering, and gradient boosting decision trees or spatial convolutional neural networks (GCN) are used for geographic relevance scoring. Examples of AI input include (1) “GPS: 35.6895,139.6917, area ID: Shinjuku-ku, Tokyo, data type: purchase history, purchase amount: 1,200 yen, payment time: 2024-06-01 12:00” and (2) “GPS: 34.6937,135.5023, area ID: Kita-ku, Osaka, data type: SNS post, post content: ‘A new cafe has opened’”. Examples of AI output include (1) “Collection priority: Shinjuku-ku=0.95, other wards=0.40” and (2) “Filtering result: only data related to Kita-ku, Osaka collected”. The collection unit controls the collection target selection module based on the AI output results to preferentially collect geographically relevant data. Subsequently, the collected data is stored in the database with geographic tags and used for regional characteristic analysis in the analysis unit and proposal unit. For AI model training, a dataset with geographic relevance labels is used, and relevance score maximization is used as the loss function. The collection unit achieves a technical effect of enabling geographic-adaptive data collection, which was difficult with conventional human manual area selection and heuristics, thereby improving the accuracy of reflecting regional characteristics, optimizing data quality, and enhancing operational efficiency. Specific application fields include urban redevelopment, real estate investment decision-making, region-specific marketing, area-specific information collection during disasters, and tourism area analysis.

The collection unit can analyze social media trends at the time of data collection and collect related data. For example, the collection unit analyzes social media trends in real time and collects related data. The collection unit can also prioritize the collection of data related to local trends based on social media trends. Furthermore, the collection unit can analyze social media trends and collect data related to specific topics. By analyzing social media trends, related data can be efficiently collected. Some or all of the above-described processing in the collection unit may be performed using AI or without using AI. For example, the collection unit may input social media trend data to AI and have the AI perform analysis to collect related data. Specifically, the collection unit collects post data obtained from SNS API (e.g., post text of 256-1024 tokens, post time, poster attributes, location information), hashtag frequency, trend word ranking, post image data, and generates features for trend analysis. For AI models, Transformer-based large language models are used for text trend extraction, convolutional neural networks (CNN) for image trend extraction, and LSTM or autoregressive models for time-series trend detection. Examples of AI input include (1) “Post text: ‘A new bakery is trending in this area’, post time: 2024-05-10 09:00, hashtag: #bakery” and (2) “Post image: cafe exterior photo, post time: 2024-05-11 14:20, location: Shibuya-ku, Tokyo”. Examples of AI output include (1) “Trend score: bakery=0.78, cafe=0.65, fitness=0.30” and (2) “Topic classification: food=0.85, leisure=0.10”. The collection unit prioritizes the collection of data related to topics or regions with high trend scores based on the AI output results. Subsequently, the collected data is stored in the database with trend tags and used for local trend analysis and business model proposals in the analysis unit and proposal unit. For AI model training, a trend-labeled SNS dataset is used, and weights are optimized using cross-entropy loss or time-series prediction error. The collection unit achieves a technical effect of enabling real-time and highly accurate trend-adaptive data collection, which was difficult with conventional human manual trend analysis and heuristics, thereby accelerating trend identification, improving data collection efficiency, and enhancing the accuracy of reflecting regional characteristics. Specific application fields include local trend analysis, product marketing, tourism demand forecasting, event effect measurement, and urban SNS monitoring.

The analysis unit can estimate a user's emotion and adjust the expression method of analysis based on the estimated emotion of the user. For example, if the user is relaxed, the analysis unit provides detailed analysis results. If the user is in a hurry, the analysis unit may provide concise analysis results focusing on key points. Furthermore, if the user is excited, the analysis unit may provide visually stimulating analysis results. By adjusting the expression method of analysis according to the user's emotion, more appropriate analysis results can be provided. Emotion estimation is realized, for example, by using an emotion engine or generative AI with emotion estimation functionality. Generative AI may include text generation AI (e.g., LLM) or multimodal generative AI, but is not limited to such examples. Some or all of the above-described processing in the analysis unit may be performed using AI or without using AI. For example, the analysis unit may input the user's facial expression data to generative AI and have the generative AI perform emotion estimation. Specifically, the analysis unit simultaneously acquires multiple modalities for user emotion estimation, such as facial image data (e.g., 128×128 pixel RGB images), audio waveform data (e.g., 3 seconds of 16 kHz sampled audio), and text data (e.g., user utterances or chat content, up to 512 tokens), and inputs these to a multimodal AI model. For image input, a convolutional neural network (CNN) is used; for audio input, a recurrent neural network (RNN) or Transformer with self-attention mechanism is used; for text input, a large language model is used. The outputs of these feature extraction layers are integrated, and a fully connected layer outputs emotion labels (e.g., relaxation, in a hurry, excitement, stress, etc.) and emotion intensity scores (e.g., continuous values from 0.0 to 1.0). Examples of AI input include (1) “Facial image: smiling, audio: high pitch, text: ‘I'm really looking forward to it!’” and (2) “Facial image: frowning, audio: low pitch, text: ‘I'm tired today.’”. Examples of AI output include (1) “Emotion label: excitement, intensity: 0.92” and (2) “Emotion label: relaxation, intensity: 0.45”. The analysis unit sends signals based on the emotion estimation results to the analysis result generation module, which dynamically switches the expression method, such as detailed analysis (e.g., multivariate graphs, factor decomposition, time-series transition graphs), concise analysis (e.g., key point summary, main indicators only), and visually stimulating analysis (e.g., animated dashboards, interactive charts). Subsequently, the analysis results are output to the user interface and presented in a form optimized for the user's emotional state. For AI model training, a multimodal dataset with emotion labels is used, and weights are optimized using cross-entropy loss or mean squared error. The analysis unit achieves a technical effect of enabling real-time and highly accurate emotion-adaptive analysis expression control, which was difficult with conventional human emotion observation and manual expression switching, thereby improving user experience, enhancing understanding of analysis results, and increasing system flexibility. Specific application fields include resident dashboards for smart cities, personalized marketing, optimization of real estate viewing experiences, stress detection-type analysis presentation in medical and nursing care settings, and learner-adaptive analysis display in education.

The analysis unit can adjust the level of detail of analysis based on the importance of the data at the time of analysis. For example, the analysis unit performs detailed analysis for highly important data. The analysis unit may also perform concise analysis for less important data. Furthermore, the analysis unit may dynamically adjust the level of detail of analysis according to the importance of the data. By adjusting the level of detail of analysis based on the importance of the data, efficient analysis becomes possible. Some or all of the above-described processing in the analysis unit may be performed using AI or without using AI. For example, the analysis unit may have AI evaluate the importance of data and perform analysis to adjust the level of detail of analysis. Specifically, the analysis unit assigns attribute information to each data item for importance evaluation (e.g., data type, occurrence frequency, contribution to past decision-making, user-specified priority score, etc.) and inputs these as feature quantities to the AI model. For AI models, gradient boosting decision trees (GBDT) or random forest are used for importance scoring, and multilayer perceptron (MLP) for importance classification. Examples of AI input include (1) “Data type: purchase history, occurrence frequency: high, contribution: 0.85, user priority: 0.90” and (2) “Data type: survey response, occurrence frequency: low, contribution: 0.40, user priority: 0.30”. Examples of AI output include (1) “Importance score: 0.92, recommended analysis detail: detailed” and (2) “Importance score: 0.35, recommended analysis detail: concise”. The analysis unit controls the analysis detail control module based on the AI output results, applying detailed analysis such as multivariate analysis, factor decomposition, and time-series analysis to highly important data, and simple analysis such as summary statistics and main indicators only to less important data. Subsequently, the analysis results are passed to the user interface and proposal unit, contributing to improved decision-making and business model proposal accuracy. For AI model training, the relationship between past analysis results and decision-making accuracy is used as training data, and decision-making accuracy and analysis efficiency maximization are used as loss functions. The analysis unit achieves a technical effect of enabling optimization of large-scale, multidimensional data analysis, which was difficult with conventional human heuristics and manual detail setting, thereby improving computational resource efficiency, analysis accuracy, and flexible response to user requirements. Specific application fields include automatic optimization of urban data platforms, personalized marketing, medical and health data analysis, optimization of IoT sensor network operation, and efficiency improvement of social surveys.

The analysis unit can apply different analysis algorithms according to the category of data at the time of analysis. For example, the analysis unit applies a purchase pattern analysis algorithm to purchase data. The analysis unit may also apply a payment trend analysis algorithm to payment data. Furthermore, the analysis unit may apply a trend analysis algorithm to local trend data. By applying different analysis algorithms according to the category of data, analysis accuracy is improved. Some or all of the above-described processing in the analysis unit may be performed using AI or without using AI. For example, the analysis unit may have AI classify the category of data and perform analysis to apply the appropriate analysis algorithm. Specifically, the analysis unit provides a category determination module for input data, inputs data type (e.g., purchase history, payment information, SNS post, survey response, etc.) as feature quantities to the AI model (e.g., decision tree, SVM, Transformer-based classifier), and outputs category labels. Examples of AI input include (1) “Data content: product ID=12345, purchase amount=800 yen, payment time=2024-05-02 10:15” and (2) “Data content: post text=‘A new cafe is trending’, post time=2024-05-10 09:00”. Examples of AI output include (1) “Category: purchase data” and (2) “Category: local trend data”. The analysis unit automatically applies a purchase pattern analysis algorithm (e.g., association analysis, clustering) to purchase data, a payment trend analysis algorithm (e.g., time-series prediction, anomaly detection) to payment data, and a trend analysis algorithm (e.g., topic modeling, time-series clustering) to local trend data according to the category determination result. Subsequently, the analysis results are passed to the application/business model proposal module and used for optimal decision-making. For AI model training, a dataset with category labels is used, and weights are optimized using cross-entropy loss. The analysis unit achieves a technical effect of enabling optimal application of analysis algorithms to various data types, which was difficult with conventional human manual algorithm selection and heuristics, thereby improving analysis accuracy, operational efficiency, and system flexibility. Specific application fields include sales analysis for commercial facilities, anomaly detection in financial transactions, local trend analysis, personalized marketing, and urban data analysis.

The analysis unit can estimate a user's emotion and adjust the display method of the analysis result based on the estimated emotion of the user. For example, if the user is nervous, the analysis unit provides a simple and highly visible display method. If the user is relaxed, the analysis unit may provide a display method including detailed information. Furthermore, if the user is in a hurry, the analysis unit may provide a display method focusing on key points. By adjusting the display method of the analysis result according to the user's emotion, more appropriate analysis results can be provided. Emotion estimation is realized, for example, by using an emotion engine or generative AI with emotion estimation functionality. Generative AI may include text generation AI (e.g., LLM) or multimodal generative AI, but is not limited to such examples. Some or all of the above-described processing in the analysis unit may be performed using AI or without using AI. For example, the analysis unit may input the user's facial expression data to generative AI and have the generative AI perform emotion estimation. Specifically, the analysis unit simultaneously acquires multiple modalities for user emotion estimation, such as facial image data (e.g., 128×128 pixel RGB images), audio waveform data (e.g., 3 seconds of 16 kHz sampled audio), and text data (e.g., user utterances or chat content, up to 512 tokens), and inputs these to a multimodal AI model. For image input, a convolutional neural network (CNN) is used; for audio input, a recurrent neural network (RNN) or Transformer with self-attention mechanism is used; for text input, a large language model is used. The outputs of these feature extraction layers are integrated, and a fully connected layer outputs emotion labels (e.g., nervous, relaxation, in a hurry, excitement, etc.) and emotion intensity scores (e.g., continuous values from 0.0 to 1.0). Examples of AI input include (1) “Facial image: neutral face, audio: slightly high pitch, text: ‘I'm a little anxious’” and (2) “Facial image: smiling, audio: calm tone, text: ‘I want to take my time’”. Examples of AI output include (1) “Emotion label: nervous, intensity: 0.80” and (2) “Emotion label: relaxation, intensity: 0.60”. The analysis unit sends signals based on the emotion estimation results to the display control module, which dynamically switches the display method, such as simple display (e.g., card-type UI with main indicators only), detailed display (e.g., multivariate graphs, factor decomposition, time-series transition graphs), and key point summary display (e.g., bullet point summary, main indicators only). Subsequently, the analysis results are output to the user interface and presented in a form optimized for the user's emotional state. For AI model training, a multimodal dataset with emotion labels is used, and weights are optimized using cross-entropy loss or mean squared error. The analysis unit achieves a technical effect of enabling real-time and highly accurate emotion-adaptive analysis display control, which was difficult with conventional human emotion observation and manual display switching, thereby improving user experience, enhancing understanding of analysis results, and increasing system flexibility. Specific application fields include resident dashboards for smart cities, personalized marketing, optimization of real estate viewing experiences, stress detection-type analysis presentation in medical and nursing care settings, and learner-adaptive analysis display in education.

The analysis unit can determine the priority of analysis based on the timing of data collection at the time of analysis. For example, the analysis unit prioritizes the analysis of the latest data and provides real-time information. The analysis unit may also analyze long-term trends based on past data. Furthermore, the analysis unit may dynamically adjust the priority of analysis according to the timing of data collection. By determining the priority of analysis based on the timing of data collection, efficient analysis becomes possible. Some or all of the above-described processing in the analysis unit may be performed using AI or without using AI. For example, the analysis unit may have AI evaluate the timing of data collection and perform analysis to determine the priority of analysis. Specifically, the analysis unit assigns attributes such as collection time (e.g., ISO8601 format timestamp), data type, and user-specified priority to each data item and inputs these as feature quantities to the AI model. For AI models, gradient boosting decision trees (GBDT) or LSTM (for time-series data) are used for priority scoring, and multilayer perceptron (MLP) for priority classification. Examples of AI input include (1) “Collection time: 2024-06-01 12:00, data type: purchase history, user priority: 0.90” and (2) “Collection time: 2023-12-15 09:30, data type: survey response, user priority: 0.40”. Examples of AI output include (1) “Priority score: 0.95, recommended analysis order: highest priority” and (2) “Priority score: 0.30, recommended analysis order: deferred”. The analysis unit controls the analysis scheduler based on the AI output results, applying real-time analysis algorithms (e.g., stream processing, immediate dashboard reflection) to the latest data and long-term trend analysis algorithms (e.g., time-series clustering, moving average analysis) to past data. Subsequently, the analysis results are passed to the application/business model proposal module and user interface and used for decision-making and report generation. For AI model training, the relationship between past analysis results and decision-making accuracy is used as training data, and decision-making accuracy and analysis efficiency maximization are used as loss functions. The analysis unit achieves a technical effect of enabling optimization of large-scale, multidimensional data analysis, which was difficult with conventional human manual priority setting and heuristics, thereby improving computational resource efficiency, analysis accuracy, and flexible response to user requirements. Specific application fields include automatic optimization of urban data platforms, personalized marketing, medical and health data analysis, optimization of IoT sensor network operation, and efficiency improvement of social surveys.

The analysis unit can refer to related external data at the time of analysis to improve the accuracy of analysis. For example, the analysis unit refers to external economic data to improve the accuracy of analysis results. The analysis unit may also refer to external weather data to improve the accuracy of analysis results. Furthermore, the analysis unit may refer to external market data to improve the accuracy of analysis results. By referring to related external data, the accuracy of analysis is improved. Some or all of the above-described processing in the analysis unit may be performed using AI or without using AI. For example, the analysis unit may input external data to AI and have the AI perform analysis to improve the accuracy of analysis results. Specifically, the analysis unit comprises an external data integration module that automatically acquires economic indicator data (e.g., GDP growth rate, consumer price index, unemployment rate), weather data (e.g., temperature, precipitation, weather events), market data (e.g., sales by industry, number of competing stores, product price trends), etc. via API and integrates them with internal data. For AI models, multivariate regression models or Transformer-based time-series models are used for external data integration, random forest for feature selection, and SHAP value analysis for estimating the impact of external data. Examples of AI input include (1) “Internal data: purchase history, external data: temperature=30°C, precipitation=0 mm, economic indicator=good” and (2) “Internal data: survey response, external data: industry sales=increasing, number of competing stores=5”. Examples of AI output include (1) “Analysis accuracy improvement score: +0.12, recommended external data: weather data” and (2) “Analysis accuracy improvement score: +0.08, recommended external data: market data”. The analysis unit controls the external data integration module based on the AI output results, adding external data features to the analysis algorithm to improve analysis accuracy. Subsequently, the analysis results are passed to the application/business model proposal module and user interface and used for decision-making and report generation. For AI model training, the relationship between the presence or absence of external data integration and analysis accuracy is used as training data, and analysis accuracy maximization is used as the loss function. The analysis unit achieves a technical effect of enabling optimization of multivariate and multi-time-series data analysis, which was difficult with conventional human manual external data reference and heuristics, thereby improving analysis accuracy, enhancing decision-making, and increasing system flexibility. Specific application fields include urban economic analysis, weather variation-adaptive business proposals, marketing with competitive analysis, real estate investment decision-making, and planning of regional revitalization policies.

The proposal unit is capable of estimating a user's emotion and adjusting the method of presenting proposals based on the estimated emotion of the user. For example, when the user is relaxed, the proposal unit provides detailed proposals. Additionally, when the user is in a hurry, the proposal unit can provide concise proposals that focus on key points. Furthermore, when the user is excited, the proposal unit can provide visually stimulating proposals. By adjusting the method of presenting proposals according to the user's emotion, more appropriate proposals can be made. Emotion estimation is realized, for example, by using an emotion engine or an emotion estimation function utilizing generative AI. Generative AI may include text generation AI (such as LLMs) or multimodal generative AI, but is not limited to these examples. Some or all of the above-described processing in the proposal unit may be performed using AI or without using AI. For example, the proposal unit may input the user's facial expression data into generative AI and have the generative AI perform emotion estimation. Specifically, the proposal unit acquires multiple modalities simultaneously for emotion estimation, such as facial image data (e.g., 128×128 pixel RGB images), audio waveform data (e.g., 3 seconds of audio sampled at 16 kHz), and text data (e.g., user utterances or chat content, up to 512 tokens), and inputs these into a multimodal AI model. For image input, the proposal unit uses a convolutional neural network (CNN); for audio input, a recurrent neural network (RNN) or a Transformer with self-attention; and for text input, a large language model. The outputs of these feature extraction layers are integrated, and a fully connected layer outputs emotion labels (e.g., relaxed, hurried, excited, stressed) and emotion intensity scores (e.g., continuous values from 0.0 to 1.0). Examples of AI input include (1) “Facial image: smiling, audio: high pitch, text: ‘I'm really looking forward to it!’” and (2) “Facial image: frowning, audio: low pitch, text: ‘I'm tired today.’” Examples of AI output include (1) “Emotion label: excited, intensity: 0.92” and (2) “Emotion label: relaxed, intensity: 0.45.” Based on the emotion estimation results, the proposal unit sends signals to the proposal generation module and dynamically switches the presentation method, such as detailed proposals (e.g., multivariate graphs, detailed explanations of recommendations, presentation of revenue forecast rationale), concise proposals (e.g., summary of key points, only main indicators), and visually stimulating proposals (e.g., animated dashboards, interactive charts). Subsequently, the proposal results are output to the user interface and presented in a form optimized for the user's emotional state. For training the AI model, a multimodal dataset with emotion labels is used, and weight optimization is performed using cross-entropy loss or mean squared error. Real-time and highly accurate emotion-adaptive proposal presentation control, which was difficult with conventional human emotion observation or manual presentation switching, becomes possible, resulting in technical effects such as improved user experience, enhanced understanding of proposal content, and increased flexibility of the entire system. Specific application fields include resident dashboards for smart cities, personalized marketing, optimization of real estate viewing experiences, stress detection-based proposal presentation in medical and nursing care settings, and learner-adaptive proposal display in the education field.

The proposal unit is capable of adjusting the level of detail of proposals at the time of proposal based on the importance of the business model. For example, the proposal unit provides detailed proposals for highly important business models. Additionally, for business models of lower importance, the proposal unit can provide concise proposals. Furthermore, the proposal unit can dynamically adjust the level of detail of proposals according to the importance of the business model. By adjusting the level of detail of proposals based on the importance of the business model, efficient proposals can be made. Some or all of the above-described processing in the proposal unit may be performed using AI or without using AI. For example, the proposal unit may have AI evaluate the importance of the business model and execute analysis to adjust the level of detail of proposals. Specifically, the proposal unit is equipped with an importance evaluation module for each business model, and inputs attribute information for each business model (e.g., market size, profitability, degree of fit with local needs, competitive situation, user-specified priority score) as features into an AI model. For the AI model, gradient boosting decision trees (GBDT) or random forests are used for importance scoring, and multilayer perceptrons (MLP) are used for importance classification. Examples of AI input include (1) “Business model: subscription-based cafe, market size: large, profitability: high, fit: 0.92, user priority: 0.90” and (2) “Business model: community-based retail, market size: medium, profitability: medium, fit: 0.70, user priority: 0.50.” Examples of AI output include (1) “Importance score: 0.95, recommended proposal detail: detailed” and (2) “Importance score: 0.40, recommended proposal detail: concise.” Based on the AI output, the proposal unit controls the proposal detail control module, applying detailed proposals such as multivariate analysis, detailed explanations of recommendations, and presentation of revenue forecast rationale to highly important business models, and concise proposals such as summaries and only main indicators to less important business models. Subsequently, the proposal results are passed to the user interface or support unit, contributing to improved accuracy in decision-making and business model execution support. For training the AI model, the relationship between past proposal results and decision-making accuracy is used as training data, and loss functions such as maximization of decision-making accuracy and proposal efficiency are used. Optimization of large-scale, multidimensional business model proposals, which was difficult with conventional human heuristics or manual detail setting, becomes possible, resulting in technical effects such as efficient use of computational resources, improved proposal accuracy, and flexible response to user requirements. Specific application fields include real estate investment decision-making, new store planning for commercial facilities, regional revitalization projects, urban redevelopment, and personalized marketing.

The proposal unit is capable of applying different proposal algorithms at the time of proposal according to the category of the business model. For example, the proposal unit applies proposal algorithms for the food and beverage industry to food and beverage business models. Additionally, the proposal unit can apply proposal algorithms for the retail industry to retail business models. Furthermore, the proposal unit can apply proposal algorithms for the service industry to service business models. By applying different proposal algorithms according to the category of the business model, the accuracy of proposals is improved. Some or all of the above-described processing in the proposal unit may be performed using AI or without using AI. For example, the proposal unit may have AI classify the category of the business model and execute analysis to apply appropriate proposal algorithms. Specifically, the proposal unit is equipped with a category determination module for input data, and inputs attributes of the business model (e.g., industry type, service format, revenue structure, target customer segment, local characteristics) as features into an AI model (e.g., decision tree, SVM, Transformer-based classifier) to output category labels. Examples of AI input include (1) “Business model: subscription-based cafe, industry: food and beverage, service format: subscription, target customers: young people” and (2) “Business model: community-based retail, industry: retail, service format: physical store, target customers: elderly.” Examples of AI output include (1) “Category: food and beverage industry” and (2) “Category: retail industry.” According to the category determination results, the proposal unit automatically applies food and beverage industry proposal algorithms (e.g., menu composition optimization, turnover rate prediction, location analysis) to food and beverage business models, retail industry proposal algorithms (e.g., product lineup optimization, inventory management, customer segmentation) to retail business models, and service industry proposal algorithms (e.g., service package design, customer satisfaction prediction) to service business models. Subsequently, the proposal results are passed to the applications and business model proposal module or support unit and used for optimal decision-making and execution support. For training the AI model, a business model dataset with category labels is used, and weight optimization is performed using cross-entropy loss. Optimal application of proposal algorithms to diverse industries and business types, which was difficult with conventional manual algorithm selection or heuristics, becomes possible, resulting in technical effects such as improved proposal accuracy, operational efficiency, and increased system flexibility. Specific application fields include industry-specific store planning for commercial facilities, region-specific business proposals, personalized marketing, and urban service design.

The proposal unit is capable of estimating a user's emotion and adjusting the length of proposals based on the estimated emotion of the user. For example, when the user is in a hurry, the proposal unit provides short and concise proposals that focus on key points. Additionally, when the user is relaxed, the proposal unit can provide longer proposals including detailed explanations. Furthermore, when the user is excited, the proposal unit can provide visually stimulating proposals. By adjusting the length of proposals according to the user's emotion, more appropriate proposals can be made. Emotion estimation is realized, for example, by using an emotion engine or an emotion estimation function utilizing generative AI. Generative AI may include text generation AI (such as LLMs) or multimodal generative AI, but is not limited to these examples. Some or all of the above-described processing in the proposal unit may be performed using AI or without using AI. For example, the proposal unit may input the user's facial expression data into generative AI and have the generative AI perform emotion estimation. Specifically, the proposal unit acquires facial image data (e.g., 128×128 pixel RGB images), audio data (e.g., 2 seconds of audio sampled at 16 kHz), and text data (e.g., chat utterances, up to 256 tokens) simultaneously for emotion estimation, and inputs these into a multimodal AI model. For image input, the proposal unit uses a CNN; for audio input, an RNN or Transformer; and for text input, a large language model, integrating each feature to output emotion labels (e.g., excited, relaxed, stressed) and emotion intensity scores (0.0 to 1.0). Examples of AI input include (1) “Facial image: smiling, audio: high pitch, text: ‘I'm really looking forward to it!’” and (2) “Facial image: frowning, audio: low pitch, text: ‘I'm tired today.’” Examples of AI output include (1) “Emotion label: excited, intensity: 0.90” and (2) “Emotion label: stressed, intensity: 0.75.” Based on the AI emotion estimation results, the proposal unit sends signals to the proposal generation module and dynamically switches the length and presentation of proposals, such as short summaries (e.g., application labels and main indicators only), detailed proposals (e.g., detailed explanations of recommendations and revenue forecasts), and visually stimulating proposals (e.g., animated dashboards). Subsequently, the proposal content is output to the user interface and presented in a form optimized for the user's emotional state. For training the AI model, a multimodal dataset with emotion labels is used, and weight optimization is performed using cross-entropy loss. Real-time and highly accurate emotion-adaptive proposal length control, which was difficult with conventional human emotion observation or manual length adjustment, becomes possible, resulting in technical effects such as improved user experience, enhanced understanding of proposal content, and increased flexibility of the entire system. Specific application fields include personalized marketing, optimization of real estate viewing experiences, learner-adaptive proposal display in the education field, and stress detection-based proposal presentation in medical and nursing care settings.

The proposal unit is capable of determining the priority of proposals at the time of proposal based on the feasibility of the business model. For example, the proposal unit prioritizes proposals for highly feasible business models. Additionally, for business models with low feasibility, the proposal unit can provide supplementary proposals. Furthermore, the proposal unit can dynamically adjust the priority of proposals according to the feasibility of the business model. By determining the priority of proposals based on the feasibility of the business model, efficient proposals can be made. Some or all of the above-described processing in the proposal unit may be performed using AI or without using AI. For example, the proposal unit may have AI evaluate the feasibility of the business model and execute analysis to determine the priority of proposals. Specifically, the proposal unit is equipped with a feasibility evaluation module for each business model, and inputs attribute information for each business model (e.g., difficulty of fundraising, possibility of technology introduction, compliance with regulations, degree of fit with local needs, past achievement scores) as features into an AI model. For the AI model, gradient boosting decision trees (GBDT) or random forests are used for feasibility scoring, and multilayer perceptrons (MLP) are used for priority classification. Examples of AI input include (1) “Business model: subscription-based cafe, fundraising difficulty: low, possibility of technology introduction: high, fit: 0.92, past achievements: yes” and (2) “Business model: community-based retail, fundraising difficulty: medium, possibility of technology introduction: medium, fit: 0.70, past achievements: no.” Examples of AI output include (1) “Feasibility score: 0.95, recommended priority: highest” and (2) “Feasibility score: 0.40, recommended priority: supplementary.” Based on the AI output, the proposal unit controls the proposal priority control module, prioritizing proposals for highly feasible business models and providing supplementary proposals or risk explanations for those with low feasibility. Subsequently, the proposal content is passed to the user interface or support unit, contributing to improved accuracy in decision-making and execution support. For training the AI model, the relationship between past execution results and decision-making accuracy is used as training data, and loss functions such as maximization of decision-making accuracy and proposal efficiency are used. Optimization of large-scale, multidimensional business model proposals, which was difficult with conventional human heuristics or manual priority setting, becomes possible, resulting in technical effects such as improved proposal accuracy, highly feasible decision-making support, and increased system flexibility. Specific application fields include real estate investment decision-making, new store planning for commercial facilities, regional revitalization projects, urban redevelopment, and personalized marketing.

The proposal unit is capable of referring to relevant market data at the time of proposal to improve the accuracy of proposals. For example, the proposal unit refers to market data to improve the accuracy of proposals. Additionally, the proposal unit can improve the accuracy of proposals based on market trend data. Furthermore, the proposal unit can refer to market competition data to improve the accuracy of proposals. By referring to relevant market data, the accuracy of proposals is improved. Some or all of the above-described processing in the proposal unit may be performed using AI or without using AI. For example, the proposal unit may input market data into AI and have the AI execute analysis to improve the accuracy of proposals. Specifically, the proposal unit is equipped with a market data integration module, automatically acquiring external market data such as industry sales, number of competing stores, product price trends, consumer trends, and trend word rankings via API, and integrating it with internal data. For the AI model, multivariate regression models or Transformer-based time series models are used for market data integration, random forests for feature selection, and SHAP value analysis for estimating the impact of external data. Examples of AI input include (1) “Internal data: purchase history, external data: industry sales=increasing, number of competing stores=5, trend word=cafe” and (2) “Internal data: survey responses, external data: product price trend=rising, consumer trend=health-oriented.” Examples of AI output include (1) “Proposal accuracy improvement score:+0.15, recommended external data: number of competing stores” and (2) “Proposal accuracy improvement score:+0.10, recommended external data: trend word.” Based on the AI output, the proposal unit controls the market data integration module, adding external market data features to the proposal algorithm to improve proposal accuracy. Subsequently, the proposal results are passed to the applications and business model proposal module or support unit and used for decision-making and execution support. For training the AI model, the relationship between the presence or absence of market data integration and proposal accuracy is used as training data, and maximization of proposal accuracy is used as the loss function. Optimization of multivariate and multi-time-series data proposals, which was difficult with conventional manual market data referencing or heuristics, becomes possible, resulting in technical effects such as improved proposal accuracy, advanced decision-making, and increased system flexibility. Specific application fields include urban economic analysis, marketing with competitive analysis, real estate investment decision-making, and planning of regional revitalization measures.

The support unit is capable of estimating a user's emotion and adjusting the support method based on the estimated emotion of the user. For example, when the user is relaxed, the support unit provides detailed support. Additionally, when the user is in a hurry, the support unit can provide concise support that focuses on key points. Furthermore, when the user is excited, the support unit can provide visually stimulating support. By adjusting the support method according to the user's emotion, more appropriate support can be provided. Emotion estimation is realized, for example, by using an emotion engine or an emotion estimation function utilizing generative AI. Generative AI may include text generation AI (such as LLMs) or multimodal generative AI, but is not limited to these examples. Some or all of the above-described processing in the support unit may be performed using AI or without using AI. For example, the support unit may input the user's facial expression data into generative AI and have the generative AI perform emotion estimation. Specifically, the support unit acquires multiple modalities simultaneously for emotion estimation, such as facial image data (e.g., 128×128 pixel RGB images), audio waveform data (e.g., 3 seconds of audio sampled at 16 kHz), and text data (e.g., user utterances or chat content, up to 512 tokens), and inputs these into a multimodal AI model. For image input, the support unit uses a convolutional neural network (CNN); for audio input, a recurrent neural network (RNN) or a Transformer with self-attention; and for text input, a large language model. The outputs of these feature extraction layers are integrated, and a fully connected layer outputs emotion labels (e.g., relaxed, hurried, excited, stressed) and emotion intensity scores (e.g., continuous values from 0.0 to 1.0). Examples of AI input include (1) “Facial image: smiling, audio: high pitch, text: ‘I'm really looking forward to it!’” and (2) “Facial image: frowning, audio: low pitch, text: ‘I'm tired today.’” Examples of AI output include (1) “Emotion label: excited, intensity: 0.92” and (2) “Emotion label: relaxed, intensity: 0.45.” Based on the emotion estimation results, the support unit sends signals to the support method generation module and dynamically switches the support method, such as detailed support (e.g., detailed explanation of funding assistance candidates, branching presentation of technical support procedures), concise support (e.g., summary of main support items, key points of application procedures), and visually stimulating support (e.g., animated support dashboard, interactive support selection UI). Subsequently, the support content is output to the user interface and presented in a form optimized for the user's emotional state. For training the AI model, a multimodal dataset with emotion labels is used, and weight optimization is performed using cross-entropy loss or mean squared error. Real-time and highly accurate emotion-adaptive support method control, which was difficult with conventional human emotion observation or manual support method switching, becomes possible, resulting in technical effects such as improved user experience, enhanced understanding of support content, and increased flexibility of the entire system. Specific application fields include startup support, business restructuring, regional revitalization projects, support for new store openings in commercial facilities, support for utilization of vacant houses, and execution support for regional revitalization measures.

The support unit is capable of analyzing past support history at the time of support to select the optimal support method. For example, the support unit identifies the most effective support method from past support history and provides that method. Additionally, the support unit can select the optimal support method for the user based on past support history. Furthermore, the support unit can analyze past support history and propose methods to improve the quality of support. By analyzing past support history, the optimal support method can be selected. Some or all of the above-described processing in the support unit may be performed using AI or without using AI. For example, the support unit may input past support history into AI and have the AI execute analysis to select the optimal support method. Specifically, the support unit records past support history as time-series data in a database, including support implementation date and time, support means (e.g., funding assistance, technical support, manual provision), user attributes (e.g., age group, industry, region), support content, and support results (e.g., execution rate, satisfaction score, reuse rate). For the AI model, long short-term memory networks (LSTM) or gradient boosting decision trees (GBDT) are used for time-series analysis, random forests for feature selection, and reinforcement learning algorithms (e.g., bandit algorithms) for support means optimization. Examples of AI input include (1) “Support date and time: 2024-05-01 10:00, means: funding assistance, user attributes: female in her 30s, result: satisfaction 0.85, reuse rate 0.60” and (2) “Support date and time: 2024-05-02 15:00, means: technical support, user attributes: male in his 40s, result: satisfaction 0.90, reuse rate 0.75.” Examples of AI output include (1) “Recommended support means: technical support, expected satisfaction: 0.92” and (2) “Recommended support means: funding assistance, expected reuse rate: 0.80.” Based on the AI output, the support unit controls the support scheduler and means selection module to automatically execute support with the optimal timing, means, and target attributes. Subsequently, the support results are recorded in the database and contribute to improving the accuracy of the support unit and feedback unit. For training the AI model, the relationship between past support history and support results is used as training data, and maximization of support efficiency and satisfaction is used as the loss function. Optimization of large-scale, multidimensional support history, which was difficult with conventional human heuristics or manual optimization, becomes possible, resulting in technical effects such as improved support quality, cost reduction, and maximization of user satisfaction. Specific application fields include startup support, business restructuring, regional revitalization projects, support for new store openings in commercial facilities, support for utilization of vacant houses, and execution support for regional revitalization measures.

The support unit is capable of customizing the means of support at the time of support based on the user's current situation. For example, when the user is busy, the support unit provides concise and prompt support. Additionally, when the user is relaxed, the support unit can provide detailed support. Furthermore, the support unit can dynamically customize the means of support according to the user's current situation. By customizing the means of support according to the user's current situation, more appropriate support can be provided. Some or all of the above-described processing in the support unit may be performed using AI or without using AI. For example, the support unit may have AI evaluate the user's current situation and execute analysis to customize the means of support. Specifically, the support unit collects behavioral logs (e.g., app usage status, access frequency, recent operation history), calendar information (e.g., presence of appointments, meeting times), biometric information (e.g., heart rate, stress indicators), and user input (e.g., self-reported busy/available status) to understand the user's current situation, and inputs these as features into an AI model. For the AI model, multilayer perceptrons (MLP) or decision trees are used for situation classification, LSTM for time-series situation estimation, and reinforcement learning algorithms for situation-adaptive support means selection. Examples of AI input include (1) “App usage: high frequency, calendar: many appointments, heart rate: high, self-report: busy” and (2) “App usage: low frequency, calendar: many openings, heart rate: stable, self-report: available.” Examples of AI output include (1) “Recommended support means: concise summary, notification method: push notification” and (2) “Recommended support means: detailed guide, notification method: email.” Based on the AI output, the support unit controls the support means generation module to automatically switch support content, notification method, and interface according to the user's situation. Subsequently, the support content is output to the user interface and presented in a form optimized for the user's situation. For training the AI model, a behavioral dataset with situation labels is used, and cross-entropy loss or maximization of situation adaptability is used as the loss function. Real-time and highly accurate situation-adaptive support means control, which was difficult with conventional human situation observation or manual customization, becomes possible, resulting in technical effects such as improved user experience, enhanced understanding of support content, and increased flexibility of the entire system. Specific application fields include startup support, business restructuring, regional revitalization projects, support for new store openings in commercial facilities, support for utilization of vacant houses, and execution support for regional revitalization measures.

The support unit is capable of estimating a user's emotion and determining the priority of support based on the estimated emotion of the user. For example, when the user is in a hurry, the support unit prioritizes important support. Additionally, when the user is relaxed, the support unit can provide detailed support. Furthermore, when the user is stressed, the support unit can prioritize support that imposes less burden. By determining the priority of support according to the user's emotion, more appropriate support can be provided. Emotion estimation is realized, for example, by using an emotion engine or an emotion estimation function utilizing generative AI. Generative AI may include text generation AI (such as LLMs) or multimodal generative AI, but is not limited to these examples. Some or all of the above-described processing in the support unit may be performed using AI or without using AI. For example, the support unit may input the user's facial expression data into generative AI and have the generative AI perform emotion estimation. Specifically, the support unit acquires multiple modalities simultaneously for emotion estimation, such as facial image data (e.g., 128×128 pixel RGB images), audio waveform data (e.g., 3 seconds of audio sampled at 16 kHz), and text data (e.g., user utterances or chat content, up to 512 tokens), and inputs these into a multimodal AI model. For image input, the support unit uses a convolutional neural network (CNN); for audio input, a recurrent neural network (RNN) or a Transformer with self-attention; and for text input, a large language model. The outputs of these feature extraction layers are integrated, and a fully connected layer outputs emotion labels (e.g., hurried, relaxed, stressed) and emotion intensity scores (e.g., continuous values from 0.0 to 1.0). Examples of AI input include (1) “Facial image: neutral, audio: slightly high pitch, text: ‘I'm in a hurry’” and (2) “Facial image: smiling, audio: calm tone, text: ‘I want to proceed slowly.’” Examples of AI output include (1) “Emotion label: hurried, intensity: 0.85” and (2) “Emotion label: relaxed, intensity: 0.60.” Based on the emotion estimation results, the support unit controls the support priority control module, prioritizing support items with high importance scores (e.g., funding assistance applications, emergency technical support) and prioritizing less burdensome support (e.g., simple manuals, FAQ presentation) for users in a stressed state. Subsequently, the support priority is recorded in the database and reflected in the processing flow of the support unit and feedback unit. For training the AI model, a multimodal dataset with emotion labels is used, and cross-entropy loss or priority optimization is used as the loss function. Real-time and highly accurate emotion-adaptive support priority control, which was difficult with conventional human emotion observation or manual priority setting, becomes possible, resulting in technical effects such as improved efficiency in providing important support, minimization of user burden, and overall system optimization. Specific application fields include startup support, business restructuring, regional revitalization projects, support for new store openings in commercial facilities, support for utilization of vacant houses, and execution support for regional revitalization measures.

The support unit is capable of selecting the optimal support method at the time of support by considering the user's geographic location information. For example, the support unit provides the optimal support method based on the user's geographic location information. Additionally, the support unit can propose relevant support resources by considering geographic location information. Furthermore, the support unit can select the optimal support means for the user based on geographic location information. By considering the user's geographic location information, the optimal support method can be selected, enabling more appropriate support. Some or all of the above-described processing in the support unit may be performed using AI or without using AI. For example, the support unit may input the user's geographic location information into AI and have the AI execute analysis to select the optimal support method. Specifically, the support unit acquires the user's GPS coordinates (e.g., latitude and longitude), area ID (e.g., municipality code), location accuracy (e.g., ±10 m), user attributes (e.g., industry, business size), and support candidate list (e.g., municipal subsidies, local financial institutions, local technical support providers), and adds geographic features. For the AI model, k-means or DBSCAN is used for spatial clustering, and gradient boosting decision trees or spatial convolutional neural networks (GCN) are used for geographic relevance scoring. Examples of AI input include (1) “GPS: 35.6895,139.6917, area ID: Shinjuku-ku, Tokyo, user industry: food and beverage, business size: small” and (2) “GPS: 34.6937,135.5023, area ID: Kita-ku, Osaka, user industry: retail, business size: medium.” Examples of AI output include (1) “Recommended support method: Shinjuku-ku subsidy A, local IT support B” and (2) “Recommended support method: Osaka financial institution C, regional expert D.” Based on the AI output, the support unit controls the support method selection module to prioritize support resources with high geographic relevance. Subsequently, the support content is stored in the database with geographic tags and used for regional characteristic analysis by the user or support unit. For training the AI model, a support history dataset with geographic relevance labels is used, and maximization of relevance scores is used as the loss function. Geographic-adaptive support method selection, which was difficult with conventional manual area selection or heuristics, becomes possible, resulting in technical effects such as improved accuracy in reflecting regional characteristics, optimization of support quality, and operational efficiency. Specific application fields include startup support, business restructuring, regional revitalization projects, support for new store openings in commercial facilities, support for utilization of vacant houses, and execution support for regional revitalization measures.

The support unit is capable of referring to relevant external resources at the time of support to improve the accuracy of support. For example, the support unit refers to external expert data to improve the accuracy of support. Additionally, the support unit can refer to external market data to improve the accuracy of support. Furthermore, the support unit can refer to external technical data to improve the accuracy of support. By referring to relevant external resources, the accuracy of support is improved. Some or all of the above-described processing in the support unit may be performed using AI or without using AI. For example, the support unit may input external resources into AI and have the AI execute analysis to improve the accuracy of support. Specifically, the support unit is equipped with an external resource integration module, automatically acquiring expert databases (e.g., industry-specific expert lists, technical advisors, consultants), market data (e.g., industry sales, number of competing stores, product price trends), and technical data (e.g., latest technology introduction cases, IT system comparison tables) via API, and integrating them with internal support data. For the AI model, multivariate regression models or Transformer-based time series models are used for external resource integration, random forests for feature selection, and SHAP value analysis for estimating the impact of external resources. Examples of AI input include (1) “Internal data: support candidates, external data: number of experts=10, market growth rate=5%, latest technology introduction case=available” and (2) “Internal data: support candidates, external data: number of competing stores=3, product price trend=stable.” Examples of AI output include (1) “Support accuracy improvement score:+0.15, recommended external resource: expert data” and (2) “Support accuracy improvement score:+0.10, recommended external resource: market data.” Based on the AI output, the support unit controls the external resource integration module, adding external resource features to the support algorithm to improve support accuracy. Subsequently, the support content is passed to the applications and business model proposal module or user interface and used for decision-making and execution support. For training the AI model, the relationship between the presence or absence of external resource integration and support accuracy is used as training data, and maximization of support accuracy is used as the loss function. Optimization of multivariate and multi-time-series data support, which was difficult with conventional manual external resource referencing or heuristics, becomes possible, resulting in technical effects such as improved support accuracy, advanced decision-making, and increased system flexibility. Specific application fields include startup support, business restructuring, regional revitalization projects, support for new store openings in commercial facilities, support for utilization of vacant houses, and execution support for regional revitalization measures.

The feedback unit is capable of estimating a user's emotion and adjusting the feedback collection method based on the estimated emotion of the user. For example, when the user is relaxed, the feedback unit requests detailed feedback. Additionally, when the user is in a hurry, the feedback unit can request concise feedback. Furthermore, when the user is excited, the feedback unit can request visually stimulating feedback. By adjusting the feedback collection method according to the user's emotion, more appropriate feedback can be obtained. Emotion estimation is realized, for example, by using an emotion engine or an emotion estimation function utilizing generative AI. Generative AI may include text generation AI (such as LLMs) or multimodal generative AI, but is not limited to these examples. Some or all of the above-described processing in the feedback unit may be performed using AI or without using AI. For example, the feedback unit may input the user's facial expression data into generative AI and have the generative AI perform emotion estimation. Specifically, the feedback unit acquires multiple modalities simultaneously for emotion estimation, such as facial image data (e.g., 128×128 pixel RGB images), audio waveform data (e.g., 3 seconds of audio sampled at 16 kHz), and text data (e.g., user utterances or chat content, up to 512 tokens), and inputs these into a multimodal AI model. For image input, the feedback unit uses a convolutional neural network (CNN); for audio input, a recurrent neural network (RNN) or a Transformer with self-attention; and for text input, a large language model. The outputs of these feature extraction layers are integrated, and a fully connected layer outputs emotion labels (e.g., relaxed, hurried, excited, stressed) and emotion intensity scores (e.g., continuous values from 0.0 to 1.0). Examples of AI input include (1) “Facial image: smiling, audio: high pitch, text: ‘I'm really looking forward to it!’” and (2) “Facial image: frowning, audio: low pitch, text: ‘I'm tired today.’” Examples of AI output include (1) “Emotion label: excited, intensity: 0.92” and (2) “Emotion label: relaxed, intensity: 0.45.” Based on the AI emotion estimation results, the feedback unit sends signals to the feedback collection method control module and dynamically switches the collection method, such as detailed feedback (e.g., expanded free text fields, multiple question prompts), concise feedback (e.g., five-point rating or one-click satisfaction), and visually stimulating feedback (e.g., interactive UI or animated evaluation screens). Subsequently, the collected feedback is recorded in the database and used for algorithm optimization and retraining in the analysis unit and proposal unit. For training the AI model, a multimodal dataset with emotion labels is used, and weight optimization is performed using cross-entropy loss or mean squared error. Real-time and highly accurate emotion-adaptive feedback collection control, which was difficult with conventional human emotion observation or manual collection method switching, becomes possible, resulting in technical effects such as improved user experience, enhanced comprehensiveness and accuracy of feedback content, and increased flexibility of the entire system. Specific application fields include urban redevelopment, real estate investment decision-making, regional revitalization projects, new store planning for commercial facilities, vacant house measures, and planning of regional revitalization measures.

The feedback unit is capable of analyzing past feedback history at the time of feedback collection to select the optimal collection method. For example, the feedback unit identifies the most effective collection method from past feedback history and provides that method. Additionally, the feedback unit can select the optimal collection method for the user based on past feedback history. Furthermore, the feedback unit can analyze past feedback history and propose methods to improve the quality of collection. By analyzing past feedback history, the optimal collection method can be selected. Some or all of the above-described processing in the feedback unit may be performed using AI or without using AI. For example, the feedback unit may input past feedback history into AI and have the AI execute analysis to select the optimal collection method. Specifically, the feedback unit records past feedback history as time-series data in a database, including collection date and time, collection means (e.g., survey, SNS review, in-app rating), user attributes (e.g., age group, region, gender), length and detail of feedback content, post-collection analysis accuracy (e.g., AI model F1 score or RMSE), feedback recovery rate, and response rate. For the AI model, long short-term memory networks (LSTM) or gradient boosting decision trees (GBDT) are used for time-series analysis, random forests for feature selection, and reinforcement learning algorithms (e.g., bandit algorithms) for collection means optimization. Examples of AI input include (1) “Collection date and time: 2024-05-01 10:00, means: survey, target: female in her 30s, content detail: high, recovery rate: 0.85, analysis accuracy: 0.82” and (2) “Collection date and time: 2024-05-02 15:00, means: SNS review, target: male in his 20s, content detail: medium, recovery rate: 0.90, analysis accuracy: 0.88.” Examples of AI output include (1) “Recommended collection means: SNS review, recommended timing: weekday 18:00, expected accuracy: 0.90” and (2) “Recommended collection means: survey, recommended target: male in his 40s, expected recovery rate: 0.80.” Based on the AI output, the feedback unit controls the collection scheduler and means selection module to automatically execute feedback collection with the optimal timing, means, and target attributes. Subsequently, the collection results are recorded in the database and contribute to improving the accuracy of the analysis unit and proposal unit. For training the AI model, the relationship between past feedback history and analysis accuracy/recovery rate is used as training data, and maximization of collection efficiency and analysis accuracy is used as the loss function. Optimization of large-scale, multidimensional feedback collection, which was difficult with conventional human heuristics or manual optimization, becomes possible, resulting in technical effects such as improved feedback quality, reduced collection costs, and maximized analysis accuracy. Specific application fields include automatic optimization of urban data platforms, personalized marketing, medical and health data collection, efficiency improvement of social surveys, and customer satisfaction surveys for commercial facilities.

The feedback unit is capable of customizing the means of collection at the time of feedback collection based on the user's current situation. For example, when the user is busy, the feedback unit performs concise and prompt feedback collection. Additionally, when the user is relaxed, the feedback unit can perform detailed feedback collection. Furthermore, the feedback unit can dynamically customize the means of collection according to the user's current situation. By customizing the means of collection according to the user's current situation, more appropriate feedback can be obtained. Some or all of the above-described processing in the feedback unit may be performed using AI or without using AI. For example, the feedback unit may have AI evaluate the user's current situation and execute analysis to customize the means of collection. Specifically, the feedback unit collects behavioral logs (e.g., app usage status, access frequency, recent operation history), calendar information (e.g., presence of appointments, meeting times), biometric information (e.g., heart rate, stress indicators), and user input (e.g., self-reported busy/available status) to understand the user's current situation, and inputs these as features into an AI model. For the AI model, multilayer perceptrons (MLP) or decision trees are used for situation classification, LSTM for time-series situation estimation, and reinforcement learning algorithms for situation-adaptive collection means selection. Examples of AI input include (1) “App usage: high frequency, calendar: many appointments, heart rate: high, self-report: busy” and (2) “App usage: low frequency, calendar: many openings, heart rate: stable, self-report: available.” Examples of AI output include (1) “Recommended collection means: concise summary, notification method: push notification” and (2) “Recommended collection means: detailed survey, notification method: email.” Based on the AI output, the feedback unit controls the collection means generation module to automatically switch feedback content, notification method, and interface according to the user's situation. Subsequently, the collection content is output to the user interface and presented in a form optimized for the user's situation. For training the AI model, a behavioral dataset with situation labels is used, and cross-entropy loss or maximization of situation adaptability is used as the loss function. Real-time and highly accurate situation-adaptive feedback collection means control, which was difficult with conventional human situation observation or manual customization, becomes possible, resulting in technical effects such as improved user experience, enhanced understanding of feedback content, and increased flexibility of the entire system. Specific application fields include startup support, business restructuring, regional revitalization projects, support for new store openings in commercial facilities, support for utilization of vacant houses, and execution support for regional revitalization measures.

The feedback unit is capable of estimating a user's emotion and determining the priority of feedback based on the estimated emotion of the user. For example, when the user is in a hurry, the feedback unit prioritizes the collection of important feedback. Additionally, when the user is relaxed, the feedback unit can collect detailed feedback. Furthermore, when the user is stressed, the feedback unit can prioritize the collection of less burdensome feedback. By determining the priority of feedback according to the user's emotion, more appropriate feedback can be obtained. Emotion estimation is realized, for example, by using an emotion engine or an emotion estimation function utilizing generative AI. Generative AI may include text generation AI (such as LLMs) or multimodal generative AI, but is not limited to these examples. Some or all of the above-described processing in the feedback unit may be performed using AI or without using AI. For example, the feedback unit may input the user's facial expression data into generative AI and have the generative AI perform emotion estimation. Specifically, the feedback unit acquires multiple modalities simultaneously for emotion estimation, such as facial image data (e.g., 128×128 pixel RGB images), audio waveform data (e.g., 3 seconds of audio sampled at 16 kHz), and text data (e.g., user utterances or chat content, up to 512 tokens), and inputs these into a multimodal AI model. For image input, the feedback unit uses a convolutional neural network (CNN); for audio input, a recurrent neural network (RNN) or a Transformer with self-attention; and for text input, a large language model. The outputs of these feature extraction layers are integrated, and a fully connected layer outputs emotion labels (e.g., hurried, relaxed, stressed) and emotion intensity scores (e.g., continuous values from 0.0 to 1.0). Examples of AI input include (1) “Facial image: neutral, audio: slightly high pitch, text: ‘I'm in a hurry’” and (2) “Facial image: smiling, audio: calm tone, text: ‘I want to proceed slowly.’” Examples of AI output include (1) “Emotion label: hurried, intensity: 0.85” and (2) “Emotion label: relaxed, intensity: 0.60.” Based on the emotion estimation results, the feedback unit controls the feedback priority control module, prioritizing feedback items with high importance scores (e.g., satisfaction with main functions, reporting of critical defects) and prioritizing less burdensome feedback (e.g., one-click evaluation, simple multiple-choice questions) for users in a stressed state. Subsequently, the feedback priority is recorded in the database and reflected in the processing flow of the feedback unit and analysis unit. For training the AI model, a multimodal dataset with emotion labels is used, and cross-entropy loss or priority optimization is used as the loss function. Real-time and highly accurate emotion-adaptive feedback priority control, which was difficult with conventional human emotion observation or manual priority setting, becomes possible, resulting in technical effects such as improved efficiency in collecting important feedback, minimization of user burden, and overall system optimization. Specific application fields include startup support, business restructuring, regional revitalization projects, support for new store openings in commercial facilities, support for utilization of vacant houses, and execution support for regional revitalization measures.

The feedback unit is capable of selecting the optimal collection method at the time of feedback collection by considering the user's geographic location information. For example, the feedback unit provides the optimal collection method based on the user's geographic location information. Additionally, the feedback unit can propose relevant feedback resources by considering geographic location information. Furthermore, the feedback unit can select the optimal collection means for the user based on geographic location information. By considering the user's geographic location information, the optimal collection method can be selected, enabling more appropriate feedback. Some or all of the above-described processing in the feedback unit may be performed using AI or without using AI. For example, the feedback unit may input the user's geographic location information into AI and have the AI execute analysis to select the optimal collection method. Specifically, the feedback unit acquires the user's GPS coordinates (e.g., latitude and longitude), area ID (e.g., municipality code), location accuracy (e.g., ±10 m), user attributes (e.g., industry, age group), and feedback candidate list (e.g., regional surveys, local event participation reviews, on-site photo submissions), and adds geographic features. For the AI model, k-means or DBSCAN is used for spatial clustering, and gradient boosting decision trees or spatial convolutional neural networks (GCN) are used for geographic relevance scoring. Examples of AI input include (1) “GPS: 35.6895,139.6917, area ID: Shinjuku-ku, Tokyo, user industry: food and beverage, age group: 30s” and (2) “GPS: 34.6937,135.5023, area ID: Kita-ku, Osaka, user industry: retail, age group: 40s.” Examples of AI output include (1) “Recommended collection method: Shinjuku-ku survey, local event review” and (2) “Recommended collection method: Osaka on-site photo submission.” Based on the AI output, the feedback unit controls the collection method selection module to prioritize feedback resources with high geographic relevance. Subsequently, the collection content is stored in the database with geographic tags and used for regional characteristic analysis by the analysis unit or feedback unit. For training the AI model, a feedback history dataset with geographic relevance labels is used, and maximization of relevance scores is used as the loss function. Geographic-adaptive feedback collection method selection, which was difficult with conventional manual area selection or heuristics, becomes possible, resulting in technical effects such as improved accuracy in reflecting regional characteristics, optimization of feedback quality, and operational efficiency. Specific application fields include startup support, business restructuring, regional revitalization projects, support for new store openings in commercial facilities, support for utilization of vacant houses, and execution support for regional revitalization measures.

The feedback unit is capable of referring to relevant external data at the time of feedback collection to improve the accuracy of collection. For example, the feedback unit refers to external market data to improve the accuracy of feedback collection. Additionally, the feedback unit can refer to external economic data to improve the accuracy of feedback collection. Furthermore, the feedback unit can refer to external technical data to improve the accuracy of feedback collection. By referring to relevant external data, the accuracy of collection is improved. Some or all of the above-described processing in the feedback unit may be performed using AI or without using AI. For example, the feedback unit may input external data into AI and have the AI execute analysis to improve the accuracy of collection. Specifically, the feedback unit is equipped with an external data integration module, automatically acquiring external data such as industry sales, number of competing stores, product price trends, consumer trends, trend word rankings, economic indicators (e.g., GDP growth rate, consumer price index), and technical data (e.g., latest technology introduction cases, IT system comparison tables) via API, and integrating them with internal feedback data. For the AI model, multivariate regression models or Transformer-based time series models are used for external data integration, random forests for feature selection, and SHAP value analysis for estimating the impact of external data. Examples of AI input include (1) “Internal data: feedback content, external data: industry sales=increasing, number of competing stores=5, trend word=cafe” and (2) “Internal data: survey responses, external data: product price trend=rising, consumer trend=health-oriented.” Examples of AI output include (1) “Collection accuracy improvement score: +0.15, recommended external data: number of competing stores” and (2) “Collection accuracy improvement score: +0.10, recommended external data: trend word.” Based on the AI output, the feedback unit controls the external data integration module, adding external data features to the feedback collection algorithm to improve collection accuracy. Subsequently, the collection content is passed to the applications and business model proposal module or user interface and used for decision-making and execution support. For training the AI model, the relationship between the presence or absence of external data integration and collection accuracy is used as training data, and maximization of collection accuracy is used as the loss function. Optimization of multivariate and multi-time-series data feedback collection, which was difficult with conventional manual external data referencing or heuristics, becomes possible, resulting in technical effects such as improved collection accuracy, advanced decision-making, and increased system flexibility. Specific application fields include urban economic analysis, marketing with competitive analysis, real estate investment decision-making, planning of regional revitalization measures, and customer satisfaction surveys for commercial facilities.

The system according to the embodiment is not limited to the examples described above and can be variously modified, for example, as follows. Specifically, the system allows for various technical variations, such as modularization of each component, integration with external services via API linkage, expansion to cloud-based distributed processing architectures, support for large-scale data analysis using parallel computing clusters with GPUs, and realization of real-time data collection and analysis through collaboration with edge devices. The system can also flexibly change the types of AI models and learning methods; for example, convolutional neural networks (CNN) for image analysis, long short-term memory networks (LSTM) or Transformers for time-series analysis, large language models for text analysis, and autoencoders or Isolation Forest for anomaly detection can be applied. The system can select database configurations from relational, NoSQL, or time-series databases, and adopt various data flow designs such as batch processing, stream processing, or event-driven processing. Furthermore, the system can adapt the user interface design to various forms, including web-based, mobile applications, voice-interactive, and AR/VR interfaces. These technical changes enable the system to be optimized for specific applications or operational environments, resulting in technical effects such as improved scalability, flexibility, operational efficiency, analysis accuracy, and user experience. Specific application fields include urban data platforms, smart city operations, optimization of commercial facility management, medical and health data analysis, and support for planning in education, tourism, disaster prevention, and regional revitalization measures, covering a wide range of areas from social infrastructure to private services.

The collection unit collects user behavior history, and the analysis unit analyzes the collected behavior history to grasp the user's interests and preferences. For example, the collection unit collects the user's website browsing history and app usage history, and the analysis unit analyzes these data to identify the content frequently accessed and the functions frequently used by the user. Additionally, the collection unit collects the user's purchase history, and the analysis unit can analyze the purchase history to grasp the user's purchasing tendencies. Furthermore, the collection unit collects the user's location information, and the analysis unit can analyze the location information to identify places visited and movement patterns of the user. By collecting and analyzing user behavior history, the user's interests and preferences can be grasped, enabling more appropriate proposals. Specifically, the collection unit automatically collects user behavior history such as web access logs (e.g., URL, access time, duration of stay), app usage logs (e.g., app ID, number of feature uses, session length), purchase history (e.g., product ID, purchase amount, purchase time), and location information (e.g., GPS coordinates, movement routes, visit frequency). The analysis unit preprocesses these diverse data as time-series tensors or categorical vectors and generates feature vectors for each user. For the AI model, recurrent neural networks (RNN) or Transformers are used for behavior pattern extraction, k-means or self-organizing maps for interest clustering, and gradient boosting decision trees (GBDT) or multilayer perceptrons (MLP) for purchase tendency estimation. Examples of AI input include (1) “Web history: news. com/health, 2024-06-01 10:00, 5 minutes stay; app usage: health management app, usage count: 3; location: 35.6895,139.6917” and (2) “Purchase history: product ID=12345, amount=1200 yen, time=2024-06-02 15:30, visited store: A.” Examples of AI output include (1) “Interest category: health=0.85, travel=0.40, gourmet=0.30” and (2) “Interest topic: fitness, recommendation score=0.78.” Based on the AI output, the analysis unit sends signals to a personalized proposal generation module for each user, automatically generating product recommendations, service guidance, event notifications, etc., according to interests and preferences. Subsequently, the proposal content is output to the user interface and used for optimizing user experience and enhancing marketing measures. For training the AI model, past behavior history and actual response/purchase data are used as training data, and maximization of recommendation accuracy, click rate, or purchase rate is used as the loss function. Real-time analysis and highly accurate interest estimation of large-scale, multidimensional behavior data, which was difficult with conventional manual analysis or simple rule-based recommendations, become possible, resulting in technical effects such as improved proposal accuracy, maximized user satisfaction, and improved system operational efficiency. Specific application fields include personalized recommendations for e-commerce sites, optimization of urban service usage, customer analysis for commercial facilities, and behavior analysis in tourism, transportation, and health fields.

The analysis unit can grasp the health status and medical needs of a region based on the collected data. For example, the analysis unit analyzes hospital visit data and pharmacy prescription data in the region to identify diseases and health issues prevalent in the area. Additionally, the analysis unit analyzes health checkup data of local residents to understand their health status and risk factors. Furthermore, the analysis unit analyzes usage data from local fitness facilities to identify residents' exercise habits and health awareness. By grasping the health status and medical needs of the region, it becomes possible to propose health promotion and medical services. Specifically, the analysis unit obtains hospital visit data (e.g., department, visit date, age group, diagnosis code), pharmacy prescription data (e.g., drug name, prescription amount, patient attributes), health checkup data (e.g., blood pressure, BMI, blood glucose level, test date), and fitness usage data (e.g., facility ID, usage frequency, type of exercise) from a time-series database, and aggregates and normalizes these data by patient/resident or region. The analysis unit performs data preprocessing such as missing value imputation and outlier removal, and generates feature vectors. As AI models, time-series clustering and LSTM are used for disease outbreak detection, random forest and multilayer perceptron (MLP) for health risk estimation, and k-means and self-organizing maps for exercise habit clustering. Examples of AI input include (1) “Visit data: department=internal medicine, age=60s, diagnosis=hypertension, visit date=2024-06-01”; (2) “Health checkup: blood pressure=140/90, BMI=27, test date=2024-05-20”. Examples of AI output include (1) “Prevalent disease: hypertension, prevalence score=0.75”; (2) “Health risk: obesity risk=0.80, lack of exercise risk=0.65”. Based on the AI output, the analysis unit sends signals to health promotion measures and medical service proposal modules, and automatically generates proposals such as holding health classes tailored to regional characteristics, preventive medical guidance, and fitness program recommendations. Subsequently, the proposed content is output to dashboards for medical institutions, local governments, and residents, and utilized in the planning of regional medical policies and health promotion measures. For AI model training, past health data and actual medical usage/health outcomes are used as training data, and loss functions such as maximizing outbreak detection accuracy and risk prediction accuracy are employed. Real-time analysis and highly accurate estimation of medical needs for multivariate and multi-time-series health data, which were difficult with manual aggregation and simple statistical analysis by humans, become possible, resulting in technical effects such as optimization of health promotion measures, efficient allocation of medical resources, and early detection of resident health risks. Specific application fields include municipal health policy planning, optimization of medical institution services, risk assessment by insurance companies, and support for regional expansion of fitness businesses.

The proposal unit can propose educational programs tailored to the educational needs of a region based on analysis results. For example, the proposal unit analyzes school performance data and survey results from educational institutions in the region to grasp the educational level and learning needs of the area. Additionally, the proposal unit analyzes occupational data of local residents to identify skills and knowledge required in the region. Furthermore, the proposal unit analyzes usage data from local educational facilities to understand the demand and usage status of educational programs. By proposing educational programs tailored to regional educational needs, it is possible to contribute to improving the quality of education and developing local human resources. Specifically, the proposal unit integrates school performance data (e.g., average scores by subject, advancement rate, distribution by grade), educational survey results (e.g., learning motivation, weak subjects, desired career path), resident occupational data (e.g., occupation, industry, required qualifications), and educational facility usage data (e.g., facility ID, usage frequency, course participation rate), and aggregates them by region or age group. The analysis unit performs data preprocessing such as encoding categorical variables and standardization, and inputs the data into AI models. AI models used include multilayer perceptron (MLP) and gradient boosting decision trees (GBDT) for educational needs estimation, clustering and principal component analysis (PCA) for skill gap analysis, and time-series models (LSTM and ARIMA) for program demand forecasting. Examples of AI input include (1) “Performance data: math=65 points, English=72 points, grade=2nd year junior high, survey: weak subject=math, desired career=STEM”; (2) “Occupational data: occupation=IT, required qualification=Basic Information, facility usage: programming course=twice a month”. Examples of AI output include (1) “Recommended educational program: math enhancement course, demand score=0.80”; (2) “Recommended skill: programming, regional need=0.75”. Based on the AI output, the proposal unit controls the educational program generation module and automatically generates curriculum design, course openings, and online learning guidance tailored to regional characteristics and age groups. Subsequently, the proposed content is output to portals for educational institutions, local governments, and residents, and utilized in the planning of educational measures and human resource development plans. For AI model training, past educational data and program participation/performance data are used as training data, and loss functions such as maximizing proposal accuracy, participation rate, and performance improvement are employed. Real-time analysis and highly accurate needs estimation for multivariate and multidimensional educational data, which were difficult with manual analysis and heuristics by humans, become possible, resulting in technical effects such as optimization of educational measures, improved efficiency of human resource development, and revitalization of the local economy. Specific application fields include municipal educational policy planning, school curriculum design, vocational training program development, and recurrent education support.

The proposal unit can propose tourism plans utilizing regional tourism resources based on analysis results. For example, the proposal unit analyzes usage data from local tourist facilities and survey results from tourists to grasp regional tourism resources and tourism needs. Additionally, the proposal unit analyzes local event information and seasonal tourism data to identify the optimal timing and content of tourism plans. Furthermore, the proposal unit analyzes usage data from local accommodation facilities to understand tourist stay patterns and accommodation needs. By proposing tourism plans utilizing regional tourism resources, it is possible to contribute to the promotion of the tourism industry and revitalization of the local economy. Specifically, the proposal unit integrates tourist facility usage data (e.g., facility ID, usage date, visitor attributes), tourism survey results (e.g., satisfaction, purpose of visit, intention to revisit), event information (e.g., event date, genre, number of participants), seasonal tourism data (e.g., monthly visitor numbers, weather, congestion level), and accommodation facility usage data (e.g., number of nights, room type, reservation channel), and aggregates them by region, period, and attribute. The analysis unit performs data preprocessing such as time-series normalization and encoding of categorical variables, and inputs the data into AI models. AI models used include multilayer perceptron (MLP) and gradient boosting decision trees (GBDT) for tourism needs estimation, reinforcement learning algorithms (e.g., Q-learning) for tourism plan optimization, and clustering and time-series clustering for stay pattern analysis. Examples of AI input include (1) “Facility usage: art museum, usage date=2024-05-10, visitor=woman in her 20s, event=art fair”; (2) “Accommodation: 2 nights, room type=Japanese-style, reservation=online, survey: satisfaction=4”. Examples of AI output include (1) “Recommended tourism plan: art tour+hot springs, demand score=0.82”; (2) “Optimal timing: May, congestion=low”. Based on the AI output, the proposal unit controls the tourism plan generation module and automatically generates tourism route design, accommodation/experience package proposals, and congestion avoidance guidance tailored to regional resources, seasons, and events. Subsequently, the proposed content is output to portals for tourism associations, local governments, and travelers, and utilized in the planning of tourism measures, promotions, and optimization of traveler experiences. For AI model training, past tourism data and actual visit/accommodation records are used as training data, and loss functions such as maximizing proposal accuracy, visit rate, and satisfaction are employed. Real-time analysis and highly accurate plan proposals for multivariate and multi-time-series tourism data, which were difficult with manual analysis and heuristics by humans, become possible, resulting in technical effects such as increased tourism industry revenue, revitalization of the local economy, and maximization of traveler satisfaction. Specific application fields include tourism promotion strategies, travel agency package development, municipal tourism policy planning, and optimization of event attraction.

The proposal unit can propose disaster prevention measures for a region based on analysis results. For example, the proposal unit analyzes regional disaster occurrence data and evacuation shelter usage data to grasp disaster risks and evacuation needs in the area. Additionally, the proposal unit analyzes disaster awareness survey data of local residents to identify residents' disaster awareness and preparedness status. Furthermore, the proposal unit analyzes infrastructure data in the region to understand infrastructure vulnerabilities and areas for improvement during disasters. By proposing disaster prevention measures, it is possible to contribute to risk reduction and ensuring the safety of residents. Specifically, the proposal unit integrates disaster occurrence data (e.g., disaster type, occurrence date and time, damage scale), evacuation shelter usage data (e.g., shelter ID, number of users, duration of stay), disaster awareness survey data (e.g., stockpile status, evacuation drill participation rate, crisis awareness score), and infrastructure data (e.g., earthquake resistance, aging, repair history of roads, bridges, and power grids), and aggregates them by region or infrastructure unit. The analysis unit performs data preprocessing such as outlier removal and encoding of categorical variables, and inputs the data into AI models. AI models used include gradient boosting decision trees (GBDT) and random forest for disaster risk estimation, multilayer perceptron (MLP) for evacuation needs prediction, and graph neural networks (GNN) and clustering for infrastructure vulnerability analysis. Examples of AI input include (1) “Disaster data: earthquake, occurrence date and time=2024-05-01 10:00, damage scale=medium, shelter usage=100 people”; (2) “Infrastructure: bridge, earthquake resistance=low, aging=high, repair=none”. Examples of AI output include (1) “Recommended disaster prevention measure: increase shelters, risk reduction score=0.80”; (2) “Infrastructure improvement: bridge reinforcement, priority=high”. Based on the AI output, the proposal unit controls the disaster prevention measure generation module and automatically generates evacuation plan formulation, stockpile deployment, and infrastructure reinforcement proposals tailored to regional characteristics and infrastructure status. Subsequently, the proposed content is output to portals for local governments, disaster prevention agencies, and residents, and utilized in the planning of disaster prevention measures and infrastructure maintenance plans. For AI model training, past disaster data and damage/evacuation records are used as training data, and loss functions such as maximizing risk reduction and safety assurance are employed. Real-time analysis and highly accurate measure proposals for multivariate and multi-time-series disaster prevention data, which were difficult with manual analysis and heuristics by humans, become possible, resulting in technical effects such as minimization of disaster risk, ensuring resident safety, and improved efficiency of infrastructure operation. Specific application fields include municipal disaster prevention planning, risk assessment by infrastructure management companies, disaster education for residents, and urban redevelopment projects.

The collection unit can estimate a user's emotion and adjust the data collection method based on the estimated emotion. For example, when the user is excited, the collection unit conducts interactive surveys to collect data that attracts the user's interest. When the user is relaxed, the collection unit conducts detailed surveys to collect data for deeper insights. Furthermore, when the user is stressed, the collection unit conducts concise surveys to reduce the user's burden. By adjusting the data collection method according to the user's emotion, more appropriate data collection becomes possible. Specifically, the collection unit simultaneously acquires multiple modalities for emotion estimation, such as facial image data (e.g., 128×128 pixel RGB images), audio waveform data (e.g., 3-second audio sampled at 16 kHz), and text data (e.g., chat utterances, up to 256 tokens), and inputs them into a multimodal AI model. For image input, convolutional neural networks (CNN) are used; for audio input, recurrent neural networks (RNN) or Transformers are used; and for text input, large language models are used. The outputs of these feature extraction layers are integrated and fully connected layers output emotion labels (e.g., excitement, relaxation, stress) and emotion intensity scores (0.0-1.0). Examples of AI input include (1) “Facial image: smile, audio: high pitch, text: ‘I'm really looking forward to it!’”; (2) “Facial image: frown, audio: low pitch, text: ‘I'm tired today’”. Examples of AI output include (1) “Emotion label: excitement, intensity: 0.90”; (2) “Emotion label: stress, intensity: 0.75”. Based on the AI emotion estimation results, the collection unit sends signals to the collection method generation module and dynamically switches collection methods such as interactive surveys (e.g., branching choices and animated UI), detailed surveys (e.g., free text fields and multiple questions), and concise surveys (e.g., one-click ratings and short questions). Subsequently, the collected content is output to the user interface and presented in a form optimized for the user's emotional state. For AI model training, multimodal datasets with emotion labels are used, and weights are optimized using cross-entropy loss and mean squared error. Real-time and highly accurate emotion-adaptive data collection control, which was difficult with human emotion observation and manual switching of collection methods, becomes possible, resulting in technical effects such as improved user experience, enhanced coverage and accuracy of collected data, and increased system flexibility. Specific application fields include personalized marketing, medical and health data collection, learner-adaptive surveys in education, and user surveys for urban services.

The analysis unit can estimate a user's emotion and adjust the notification method of analysis results based on the estimated emotion. For example, when the user is relaxed, the analysis unit notifies detailed analysis results by email. When the user is in a hurry, the analysis unit provides concise analysis results focusing on key points via push notification. Furthermore, when the user is excited, the analysis unit displays visually attractive analysis results on a dashboard. By adjusting the notification method of analysis results according to the user's emotion, more appropriate information provision becomes possible. Specifically, the analysis unit simultaneously acquires multiple modalities for emotion estimation, such as facial image data (e.g., 128×128 pixel RGB images), audio waveform data (e.g., 3-second audio sampled at 16 kHz), and text data (e.g., chat utterances, up to 256 tokens), and inputs them into a multimodal AI model. For image input, convolutional neural networks (CNN) are used; for audio input, recurrent neural networks (RNN) or Transformers are used; and for text input, large language models are used. The outputs of these feature extraction layers are integrated and fully connected layers output emotion labels (e.g., relaxation, hurry, excitement) and emotion intensity scores (0.0-1.0). Examples of AI input include (1) “Facial image: smile, audio: calm tone, text: ‘I want to take my time’”; (2) “Facial image: neutral, audio: slightly high pitch, text: ‘I'm in a hurry’”. Examples of AI output include (1) “Emotion label: relaxation, intensity: 0.60”; (2) “Emotion label: hurry, intensity: 0.85”. Based on the AI emotion estimation results, the analysis unit sends signals to the notification method control module and dynamically switches notification methods such as detailed notification (e.g., email with multivariate graphs), concise notification (e.g., push notification with key indicators only), and visual notification (e.g., animated dashboard). Subsequently, the analysis results are output to the user interface and presented in a form optimized for the user's emotional state. For AI model training, multimodal datasets with emotion labels are used, and weights are optimized using cross-entropy loss and mean squared error. Real-time and highly accurate emotion-adaptive analysis notification control, which was difficult with human emotion observation and manual switching of notification methods, becomes possible, resulting in technical effects such as improved user experience, optimized information transmission efficiency, and increased system flexibility. Specific application fields include personalized marketing, medical and health data analysis notification, learner-adaptive notification in education, and user notification for urban services.

The proposal unit can estimate a user's emotion and adjust the timing of proposals based on the estimated emotion. For example, when the user is relaxed, the proposal unit selects the timing to provide detailed proposals. When the user is in a hurry, the proposal unit can quickly provide concise proposals. Furthermore, when the user is excited, the proposal unit selects the timing to provide visually attractive proposals. By adjusting the timing of proposals according to the user's emotion, more appropriate proposals become possible. Specifically, the proposal unit simultaneously acquires multiple modalities for emotion estimation, such as facial image data (e.g., 128×128 pixel RGB images), audio waveform data (e.g., 3-second audio sampled at 16 kHz), and text data (e.g., chat utterances, up to 256 tokens), and inputs them into a multimodal AI model. For image input, convolutional neural networks (CNN) are used; for audio input, recurrent neural networks (RNN) or Transformers are used; and for text input, large language models are used. The outputs of these feature extraction layers are integrated and fully connected layers output emotion labels (e.g., relaxation, hurry, excitement) and emotion intensity scores (0.0-1.0). Examples of AI input include (1) “Facial image: smile, audio: calm tone, text: ‘I want to take my time’”; (2) “Facial image: neutral, audio: slightly high pitch, text: ‘I'm in a hurry’”. Examples of AI output include (1) “Emotion label: relaxation, intensity: 0.60”; (2) “Emotion label: hurry, intensity: 0.85”. Based on the AI emotion estimation results, the proposal unit sends signals to the proposal timing control module and dynamically switches proposal timing, such as selecting the optimal timing for detailed proposals (e.g., proposals with multivariate graphs), immediate concise proposals (e.g., proposals with only key indicators), and selecting the optimal timing for visual proposals (e.g., animated dashboard). Subsequently, the proposed content is output to the user interface and presented in a form optimized for the user's emotional state. For AI model training, multimodal datasets with emotion labels are used, and weights are optimized using cross-entropy loss and mean squared error. Real-time and highly accurate emotion-adaptive proposal timing control, which was difficult with human emotion observation and manual timing adjustment, becomes possible, resulting in technical effects such as improved user experience, enhanced understanding of proposed content, and increased system flexibility. Specific application fields include personalized marketing, medical and health proposal notification, learner-adaptive proposals in education, and user proposals for urban services.

The support unit can estimate a user's emotion and adjust the content of support based on the estimated emotion. For example, when the user is relaxed, the support unit provides detailed support content. When the user is in a hurry, the support unit can provide concise support content focusing on key points. Furthermore, when the user is excited, the support unit can provide visually attractive support content. By adjusting the content of support according to the user's emotion, more appropriate support becomes possible. Specifically, the support unit simultaneously acquires multiple modalities for emotion estimation, such as facial image data (e.g., 128×128 pixel RGB images), audio waveform data (e.g., 3-second audio sampled at 16 kHz), and text data (e.g., chat utterances, up to 256 tokens), and inputs them into a multimodal AI model. For image input, convolutional neural networks (CNN) are used; for audio input, recurrent neural networks (RNN) or Transformers are used; and for text input, large language models are used. The outputs of these feature extraction layers are integrated and fully connected layers output emotion labels (e.g., relaxation, hurry, excitement) and emotion intensity scores (0.0-1.0). Examples of AI input include (1) “Facial image: smile, audio: calm tone, text: ‘I want to proceed slowly’”; (2) “Facial image: neutral, audio: slightly high pitch, text: ‘I'm in a hurry’”. Examples of AI output include (1) “Emotion label: relaxation, intensity: 0.60”; (2) “Emotion label: hurry, intensity: 0.85”. Based on the AI emotion estimation results, the support unit sends signals to the support content generation module and dynamically switches support content such as detailed support (e.g., step-by-step guides and FAQs), concise support (e.g., key point summaries), and visual support (e.g., animated support UI). Subsequently, the support content is output to the user interface and presented in a form optimized for the user's emotional state. For AI model training, multimodal datasets with emotion labels are used, and weights are optimized using cross-entropy loss and mean squared error. Real-time and highly accurate emotion-adaptive support content control, which was difficult with human emotion observation and manual switching of support content, becomes possible, resulting in technical effects such as improved user experience, enhanced understanding of support content, and increased system flexibility. Specific application fields include startup support, business restructuring, regional revitalization projects, support for new store openings in commercial facilities, support for utilization of vacant houses, and execution support for regional revitalization measures.

The feedback unit can estimate a user's emotion and adjust the feedback collection method based on the estimated emotion. For example, when the user is relaxed, the feedback unit requests detailed feedback. When the user is in a hurry, the feedback unit can request concise feedback. Furthermore, when the user is excited, the feedback unit can request visually attractive feedback. By adjusting the feedback collection method according to the user's emotion, more appropriate feedback becomes possible. Specifically, the feedback unit simultaneously acquires multiple modalities for emotion estimation, such as facial image data (e.g., 128×128 pixel RGB images), audio waveform data (e.g., 3-second audio sampled at 16 kHz), and text data (e.g., chat utterances, up to 256 tokens), and inputs them into a multimodal AI model. For image input, convolutional neural networks (CNN) are used; for audio input, recurrent neural networks (RNN) or Transformers are used; and for text input, large language models are used. The outputs of these feature extraction layers are integrated and fully connected layers output emotion labels (e.g., relaxation, hurry, excitement) and emotion intensity scores (0.0-1.0). Examples of AI input include (1) “Facial image: smile, audio: calm tone, text: ‘I want to proceed slowly’”; (2) “Facial image: neutral, audio: slightly high pitch, text: ‘I'm in a hurry’”. Examples of AI output include (1) “Emotion label: relaxation, intensity: 0.60”; (2) “Emotion label: hurry, intensity: 0.85”. Based on the AI emotion estimation results, the feedback unit sends signals to the collection method control module and dynamically switches collection methods such as detailed feedback (e.g., free text fields and multiple questions), concise feedback (e.g., one-click ratings and short questions), and visual feedback (e.g., animated evaluation UI). Subsequently, the feedback content is output to the user interface and presented in a form optimized for the user's emotional state. For AI model training, multimodal datasets with emotion labels are used, and weights are optimized using cross-entropy loss and mean squared error. Real-time and highly accurate emotion-adaptive feedback collection control, which was difficult with human emotion observation and manual switching of collection methods, becomes possible, resulting in technical effects such as improved user experience, enhanced coverage and accuracy of feedback content, and increased system flexibility. Specific application fields include urban redevelopment, real estate investment decision-making, regional revitalization projects, new store opening planning for commercial facilities, vacant house countermeasures, and planning of regional revitalization measures.

Below, the processing flow of Example of the Embodiment is briefly described. Specifically, the system is composed of multiple modules such as a collection unit, analysis unit, and proposal unit, with a clearly designed data flow between each module. The system automates the entire process from data collection to analysis and proposal generation, achieving high-precision processing by AI models at each stage. The collection unit automatically collects data from various data sources such as sensor data, SNS posts, survey results, purchase and payment information, and location information, and stores them in a database. The analysis unit preprocesses the collected data as time-series tensors and categorical vectors, inputs them into AI models (e.g., CNN, LSTM, Transformer, GBDT, etc.), and performs extraction of local characteristics, trend detection, user attribute estimation, and needs analysis. Examples of AI input include (1) “Post text: ‘A new bakery is trending in this area’, post time: 2024-05-10 09:00, hashtag: #bakery”; (2) “Purchase history: product ID=12345, amount=800 yen, payment time=2024-05-02 10:15”. Examples of AI output include (1) “Trend score: bakery=0.78, cafe=0.65”; (2) “Category: purchase data”. The proposal unit controls the applications and business model proposal module based on the analysis results, and automatically generates optimal application proposals, business model designs, and service guidance tailored to local characteristics and user attributes. Subsequently, the proposed content is output to the user interface, support unit, and feedback unit, and utilized for decision-making, execution support, and algorithm retraining. For AI model training, trend-labeled datasets and past decision-making and outcome data are used as training data, and loss functions such as maximizing analysis accuracy and proposal efficiency are employed. Real-time analysis and highly accurate proposals for applications and business models using large-scale, multidimensional data, which were difficult with manual analysis and heuristics by humans, become possible, resulting in technical effects such as improved system operation efficiency, advanced decision-making, and optimized user experience. Specific application fields include urban data platforms, smart city operation, optimization of commercial facility management, medical and health data analysis, and support for planning in education, tourism, disaster prevention, and regional revitalization measures.

Step 1: The collection unit collects data. The data includes local trends, age and gender of residents, surrounding stores, purchase and payment information, customer unit price, and more. The collection unit grasps trending products and services in the region, as well as the distribution of residents' age groups and gender, from SNS post content and survey results. Additionally, from electronic payment systems and POS systems, it can also grasp which stores sell which products and the level of customer unit price. Step 2: The analysis unit analyzes the data collected by the collection unit using AI. AI utilizes technologies such as deep learning and natural language processing to grasp local characteristics and resident needs. For example, it analyzes local trends, resident attributes, purchase and payment information, and identifies popular products and services and resident needs in the region. Step 3: The proposal unit proposes optimal applications and business models based on the analysis results obtained by the analysis unit. For example, if the AI analysis reveals that cafes are popular in the region, it proposes opening a cafe. In areas with a high proportion of elderly residents, it can also propose opening services or facilities for seniors. Specifically, in Step 1, the system's collection unit automatically collects various data such as SNS posts (e.g., text, images, post time, location information), survey results (e.g., question ID, response content, response time), store lists (e.g., store ID, business type, location), purchase and payment information (e.g., product ID, amount, payment time, payment method), and customer unit price data (e.g., average unit price per store ID), and stores them in a database. In Step 2, the analysis unit preprocesses the collected data as time-series tensors and categorical vectors, inputs them into AI models (e.g., Transformer-based large language models, CNN, LSTM, GBDT, etc.), and performs extraction of regional trends, resident attribute estimation, purchase pattern analysis, and payment trend detection. Examples of AI input include (1) “Post text: ‘A new bakery is trending in this area’, post time: 2024-05-10 09:00, hashtag: #bakery”; (2) “Purchase history: product ID=12345, amount=800 yen, payment time=2024-05-02 10:15”. Examples of AI output include (1) “Trend score: bakery=0.78, cafe=0.65”; (2) “Category: purchase data”. Based on the AI output, the analysis unit generates rankings of popular products and services by region, resident attribute distributions, and purchase trend graphs. In Step 3, the proposal unit inputs the analysis results into the applications and business model proposal module, and automatically generates optimal application proposals (e.g., opening a cafe, services for seniors, event planning), business model designs (e.g., subscription-based cafe, community-focused retail), and service guidance tailored to local characteristics and resident attributes. Subsequently, the proposed content is output to the user interface, support unit, and feedback unit, and utilized for decision-making, execution support, and algorithm retraining. For AI model training, trend-labeled datasets and past decision-making and outcome data are used as training data, and loss functions such as maximizing analysis accuracy and proposal efficiency are employed. Real-time analysis and highly accurate proposals for applications and business models using large-scale, multidimensional data, which were difficult with manual analysis and heuristics by humans, become possible, resulting in technical effects such as improved system operation efficiency, advanced decision-making, and optimized user experience. Specific application fields include urban data platforms, smart city operation, optimization of commercial facility management, medical and health data analysis, and support for planning in education, tourism, disaster prevention, and regional revitalization measures.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned collection unit, analysis unit, proposal unit, support unit, and feedback unit is implemented by at least one of, for example, the smart device 14 and the data processing apparatus 12. For example, the collection unit collects data using the camera 42 or microphone 38B of the smart device 14 and processes the data by the control unit 46A. The analysis unit is implemented, for example, by a specific processing unit 290 of the data processing apparatus 12, and AI analyzes the collected data. The proposal unit is implemented, for example, by the specific processing unit 290 of the data processing apparatus 12 and proposes optimal applications and business models based on the analysis result. The support unit is implemented, for example, by the specific processing unit 290 of the data processing apparatus 12 and assists in the execution of the proposed business model. The feedback unit is implemented, for example, by the control unit 46A of the smart device 14 and collects feedback on the proposed content. The correspondence between each unit and the device or control unit is not limited to the examples described above and various modifications are possible. [Second Embodiment]

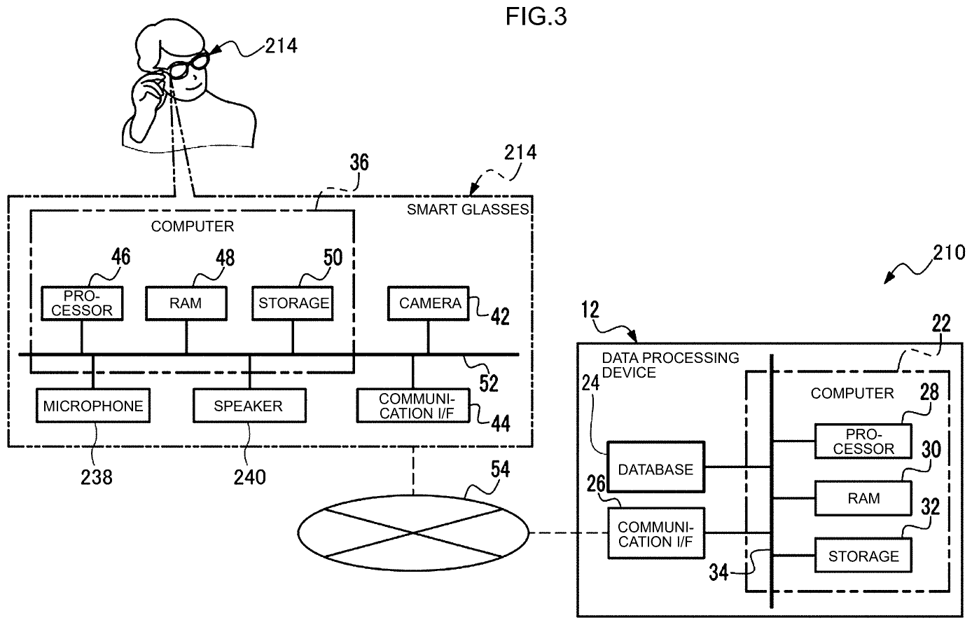

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

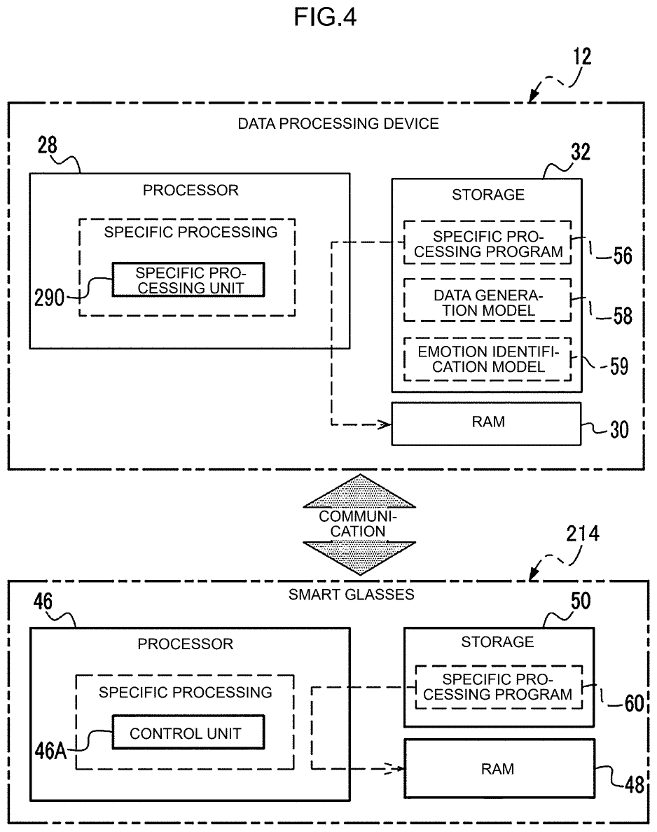

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned collection unit, analysis unit, proposal unit, support unit, and feedback unit is implemented by at least one of, for example, the smart glasses 214 and the data processing apparatus 12. For example, the collection unit collects data using the camera 42 or microphone 238 of the smart glasses 214 and processes the data by the control unit 46A. The analysis unit is implemented, for example, by a specific processing unit 290 of the data processing apparatus 12, and AI analyzes the collected data. The proposal unit is implemented, for example, by the specific processing unit 290 of the data processing apparatus 12 and proposes optimal applications and business models based on the analysis result. The support unit is implemented, for example, by the specific processing unit 290 of the data processing apparatus 12 and assists in the execution of the proposed business model. The feedback unit is implemented, for example, by the control unit 46A of the smart glasses 214 and collects feedback on the proposed content. The correspondence between each unit and the device or control unit is not limited to the examples described above and various modifications are possible. [Third Embodiment]

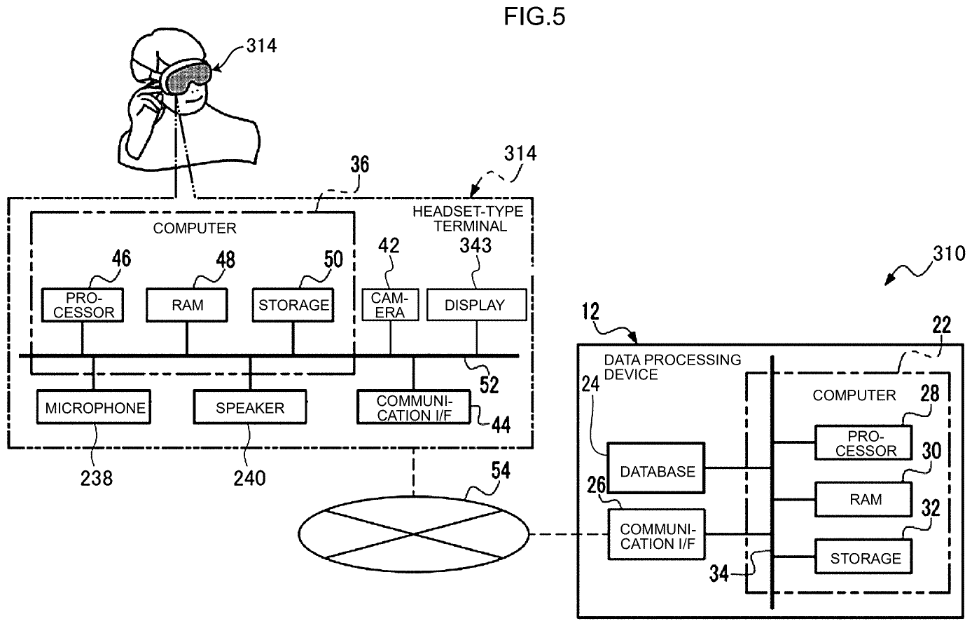

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

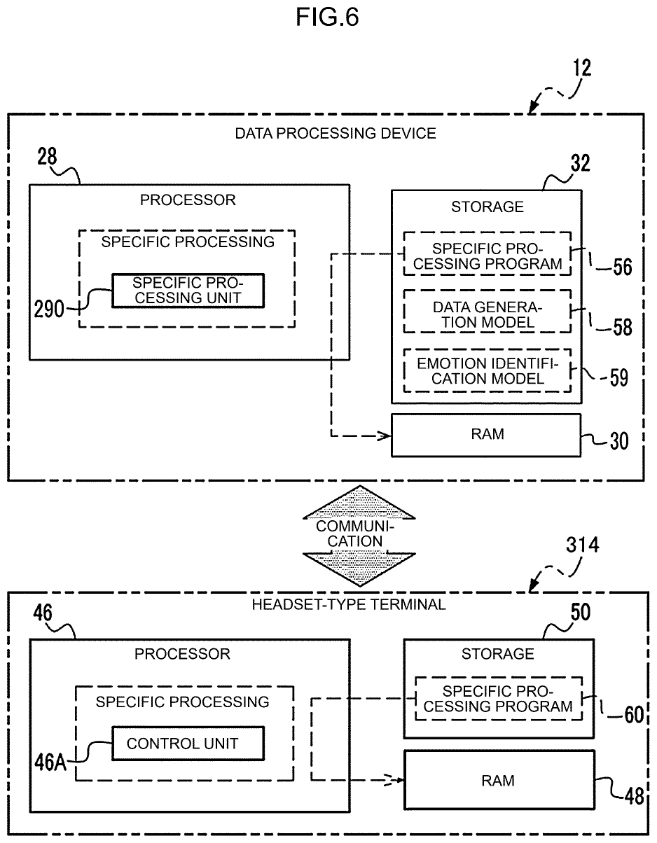

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned collection unit, analysis unit, proposal unit, support unit, and feedback unit is implemented by at least one of, for example, the headset-type terminal 314 and the data processing apparatus 12. For example, the collection unit collects data using the camera 42 or microphone 238 of the headset-type terminal 314 and processes the data by the control unit 46A. The analysis unit is implemented, for example, by a specific processing unit 290 of the data processing apparatus 12, and AI analyzes the collected data. The proposal unit is implemented, for example, by the specific processing unit 290 of the data processing apparatus 12 and proposes optimal applications and business models based on the analysis result. The support unit is implemented, for example, by the specific processing unit 290 of the data processing apparatus 12 and assists in the execution of the proposed business model. The feedback unit is implemented, for example, by the control unit 46A of the headset-type terminal 314 and collects feedback on the proposed content. The correspondence between each unit and the device or control unit is not limited to the examples described above and various modifications are possible.

### Fourth Embodiment

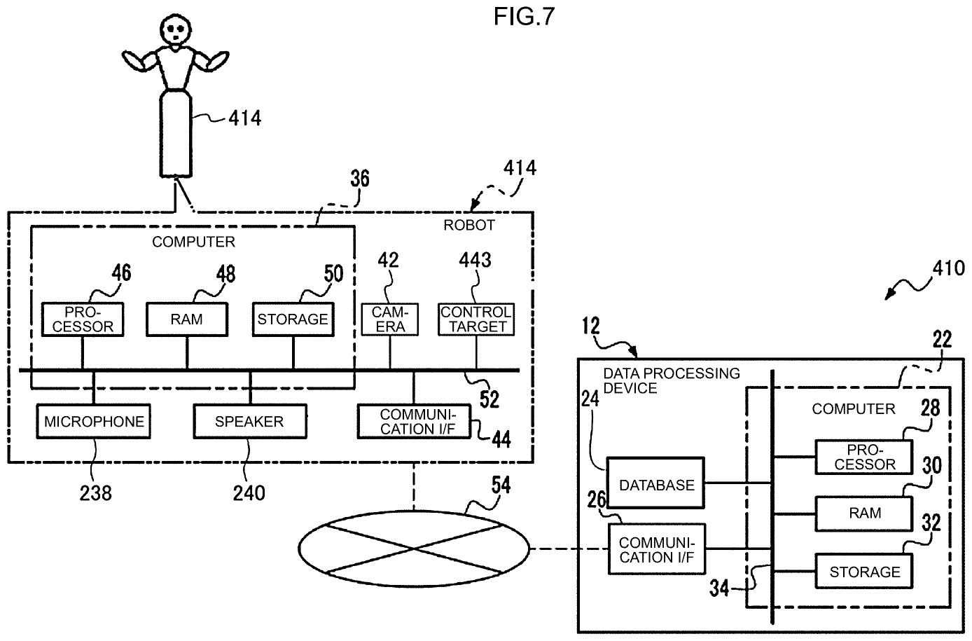

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

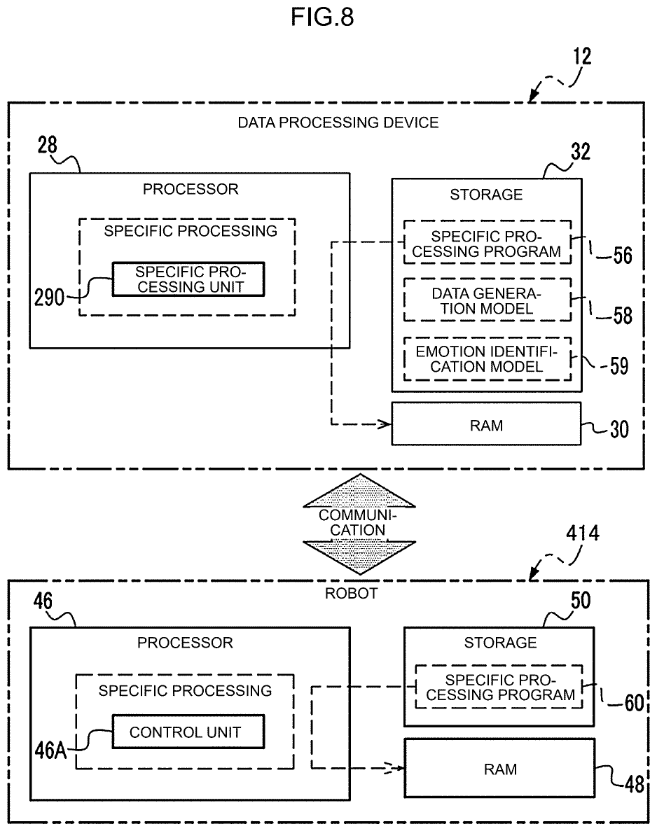

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned collection unit, analysis unit, proposal unit, support unit, and feedback unit is implemented by at least one of, for example, the robot 414 and the data processing apparatus 12. For example, the collection unit collects data using the camera 42 or microphone 238 of the robot 414 and processes the data by the control unit 46A. The analysis unit is implemented, for example, by a specific processing unit 290 of the data processing apparatus 12, and AI analyzes the collected data. The proposal unit is implemented, for example, by the specific processing unit 290 of the data processing apparatus 12 and proposes optimal applications and business models based on the analysis result. The support unit is implemented, for example, by the specific processing unit 290 of the data processing apparatus 12 and assists in the execution of the proposed business model. The feedback unit is implemented, for example, by the control unit 46A of the robot 414 and collects feedback on the proposed content. The correspondence between each unit and the device or control unit is not limited to the examples described above and various modifications are possible.

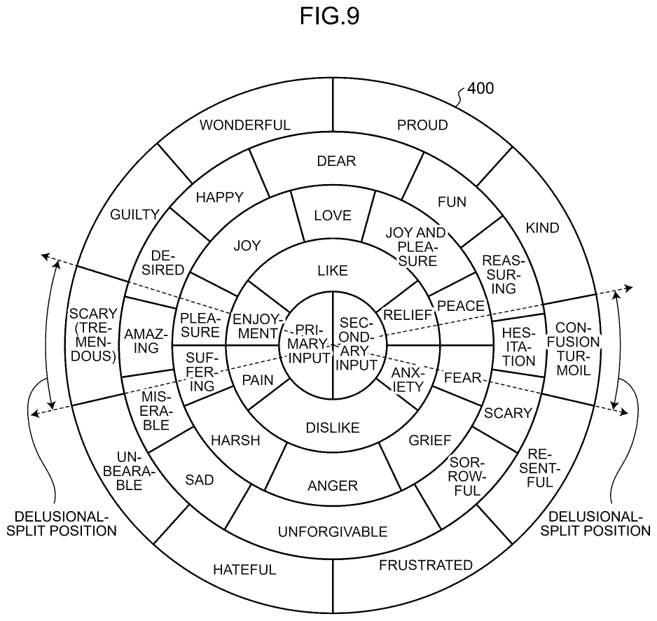

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

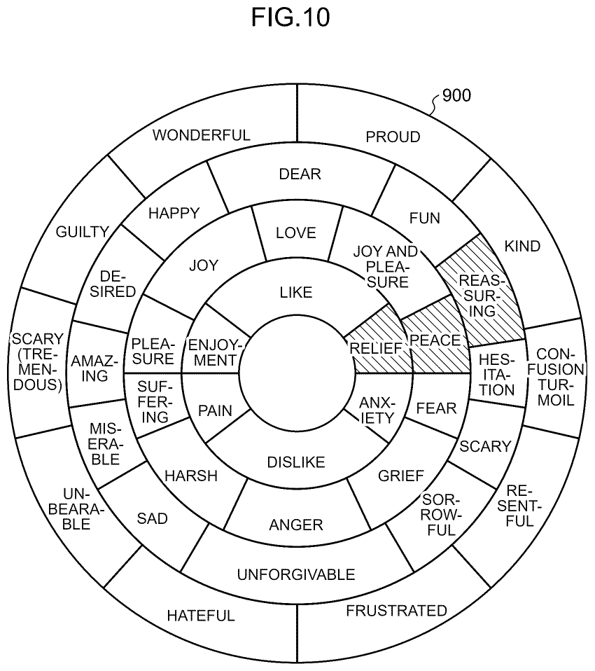

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a collection unit configured to collect data; an analysis unit configured to analyze the data collected by the collection unit; and a proposal unit configured to propose applications and business models based on an analysis result obtained by the analysis unit.
(Supplementary Note 2) The system according to Supplementary Note 1, wherein the collection unit is configured to collect data including local trends, age and gender of residents, surrounding stores, purchase and payment information, customer unit price, and other data.
(Supplementary Note 3) The system according to Supplementary Note 1, wherein the analysis unit is configured to analyze the collected data using AI and to grasp local characteristics and resident needs.
(Supplementary Note 4) The system according to Supplementary Note 1, wherein the proposal unit is configured to propose applications and business models for the land or property based on the analysis result.
(Supplementary Note 5) The system according to Supplementary Note 1, wherein the proposal unit includes a support unit configured to assist in the execution of the proposed business model.
(Supplementary Note 6) The system according to Supplementary Note 1, wherein the proposal unit includes a feedback unit configured to collect feedback on the proposed content.
(Supplementary Note 7) The system according to Supplementary Note 1, wherein the collection unit is configured to estimate a user's emotion and adjust the timing of data collection based on the estimated emotion of the user.
(Supplementary Note 8) The system according to Supplementary Note 1, wherein the collection unit is configured to analyze past data collection history and select an optimal collection method.
(Supplementary Note 9) The system according to Supplementary Note 1, wherein the collection unit is configured to filter collection targets at the time of data collection based on local events and seasonal variations.
(Supplementary Note 10) The system according to Supplementary Note 1, wherein the collection unit is configured to estimate a user's emotion and determine the priority of data to be collected based on the estimated emotion of the user.
(Supplementary Note 11) The system according to Supplementary Note 1, wherein the collection unit is configured to preferentially collect highly relevant data at the time of data collection by considering the geographic location information of the region.
(Supplementary Note 12) The system according to Supplementary Note 1, wherein the collection unit is configured to analyze social media trends at the time of data collection and collect related data.
(Supplementary Note 13) The system according to Supplementary Note 1, wherein the analysis unit is configured to estimate a user's emotion and adjust the expression method of analysis based on the estimated emotion of the user.
(Supplementary Note 14) The system according to Supplementary Note 1, wherein the analysis unit is configured to adjust the level of detail of analysis based on the importance of the data at the time of analysis.
(Supplementary Note 15) The system according to Supplementary Note 1, wherein the analysis unit is configured to apply different analysis algorithms according to the category of data at the time of analysis.
(Supplementary Note 16) The system according to Supplementary Note 1, wherein the analysis unit is configured to estimate a user's emotion and adjust the display method of the analysis result based on the estimated emotion of the user.
(Supplementary Note 17) The system according to Supplementary Note 1, wherein the analysis unit is configured to determine the priority of analysis based on the timing of data collection at the time of analysis.
(Supplementary Note 18) The system according to Supplementary Note 1, wherein the analysis unit is configured to refer to related external data at the time of analysis to improve the accuracy of analysis.
(Supplementary Note 19) The system according to Supplementary Note 1, wherein the proposal unit is configured to estimate a user's emotion and adjust the expression method of proposals based on the estimated emotion of the user.
(Supplementary Note 20) The system according to Supplementary Note 1, wherein the proposal unit is configured to adjust the level of detail of proposals based on the importance of the business model at the time of proposal.
(Supplementary Note 21) The system according to Supplementary Note 1, wherein the proposal unit is configured to apply different proposal algorithms according to the category of the business model at the time of proposal.
(Supplementary Note 22) The system according to Supplementary Note 1, wherein the proposal unit is configured to estimate a user's emotion and adjust the length of proposals based on the estimated emotion of the user.
(Supplementary Note 23) The system according to Supplementary Note 1, wherein the proposal unit is configured to determine the priority of proposals based on the feasibility of the business model at the time of proposal.
(Supplementary Note 24) The system according to Supplementary Note 1, wherein the proposal unit is configured to refer to related market data at the time of proposal to improve the accuracy of proposals.
(Supplementary Note 25) The system according to Supplementary Note 2, wherein the support unit is configured to estimate a user's emotion and adjust the support method based on the estimated emotion of the user.
(Supplementary Note 26) The system according to Supplementary Note 2, wherein the support unit is configured to analyze past support history at the time of support and select an optimal support method.
(Supplementary Note 27) The system according to Supplementary Note 2, wherein the support unit is configured to customize the means of support based on the current situation of the user at the time of support.
(Supplementary Note 28) The system according to Supplementary Note 2, wherein the support unit is configured to estimate a user's emotion and determine the priority of support based on the estimated emotion of the user.
(Supplementary Note 29) The system according to Supplementary Note 2, wherein the support unit is configured to select an optimal support method at the time of support by considering the geographic location information of the user.
(Supplementary Note 30) The system according to Supplementary Note 2, wherein the support unit is configured to refer to related external resources at the time of support to improve the accuracy of support.
(Supplementary Note 31) The system according to Supplementary Note 3, wherein the feedback unit is configured to estimate a user's emotion and adjust the feedback collection method based on the estimated emotion of the user.
(Supplementary Note 32) The system according to Supplementary Note 3, wherein the feedback unit is configured to analyze past feedback history at the time of feedback collection and select an optimal collection method.
(Supplementary Note 33) The system according to Supplementary Note 3, wherein the feedback unit is configured to customize the means of collection based on the current situation of the user at the time of feedback collection.
(Supplementary Note 34) The system according to Supplementary Note 3, wherein the feedback unit is configured to estimate a user's emotion and determine the priority of feedback based on the estimated emotion of the user.
(Supplementary Note 35) The system according to Supplementary Note 3, wherein the feedback unit is configured to select an optimal collection method at the time of feedback collection by considering the geographic location information of the user.
(Supplementary Note 36) The system according to Supplementary Note 3, wherein the feedback unit is configured to refer to related external data at the time of feedback collection to improve the accuracy of collection.

What is claimed is:

1. A system comprising:
circuitry configured to:
acquire input data from a plurality of data sources via a packet-switched network;
generate a multidimensional input tensor by preprocessing the input data, the preprocessing comprising tokenization of text data and normalization of numerical data;
extract a feature vector from the multidimensional input tensor by inputting the multidimensional input tensor into a trained neural network comprising a Transformer-based model and a convolutional neural network;
generate inference data by inputting the feature vector into a data generation model stored in a memory of the system, the data generation model comprising a generative artificial intelligence model trained by deep learning on a neural network; and
transmit the inference data to a client terminal via the packet-switched network.

2. The system according to claim 1, wherein the input data comprises text data collected from a social networking service, survey response data, transaction data from an electronic payment system, and point-of-sale data.

3. The system according to claim 1, wherein the preprocessing further comprises missing value imputation, outlier removal, and one-hot encoding of categorical variables.

4. The system according to claim 1, wherein the trained neural network further comprises a gradient boosting decision tree, and the circuitry is configured to extract the feature vector by combining outputs of the Transformer-based model, the convolutional neural network, and the gradient boosting decision tree.

5. The system according to claim 1, wherein the multidimensional input tensor comprises an N-by-D dimensional numerical matrix, where N corresponds to a number of data records and D corresponds to a number of feature dimensions.

6. The system according to claim 1, wherein the inference data comprises structured data including a classification label, a recommendation score, and a fitness score.

7. The system according to claim 1, wherein the circuitry is further configured to generate the inference data by applying a reinforcement learning algorithm to the feature vector.

8. The system according to claim 1, wherein the circuitry is further configured to:
acquire multimodal sensor data from the client terminal, the multimodal sensor data comprising at least two of image data, audio waveform data, and text data;
compute an emotion value by inputting the multimodal sensor data into an emotion identification model stored in the memory; and
adjust a processing parameter based on the emotion value.

9. The system according to claim 8, wherein the emotion identification model comprises a convolutional neural network for processing the image data, a recurrent neural network for processing the audio waveform data, and a large language model for processing the text data, and a fully connected layer that integrates outputs of the convolutional neural network, the recurrent neural network, and the large language model to output the emotion value.

10. The system according to claim 8, wherein the emotion identification model determines the emotion value according to an emotion map in which a plurality of emotions are mapped concentrically, with primitive emotional states arranged closer to a center and behavioral emotional states arranged on an outer side.

11. The system according to claim 8, wherein the circuitry is configured to adjust the processing parameter by selecting, based on the emotion value, one of a detailed output mode, a concise output mode, and a visual output mode for the inference data transmitted to the client terminal.

12. The system according to claim 1, wherein the circuitry is further configured to:
retrieve time-series records of prior data acquisitions from a database; and
select an optimal data acquisition method by inputting the time-series records into a long short-term memory network.

13. The system according to claim 1, wherein the circuitry is further configured to filter the input data based on event metadata and temporal variation data by computing a relevance score using a decision tree model.

14. The system according to claim 1, wherein the circuitry is further configured to assign a geographic relevance score to the input data based on location coordinates by applying a spatial clustering algorithm and to preferentially process input data having a geographic relevance score above a threshold.

15. The system according to claim 1, wherein the circuitry is further configured to:
acquire external reference data via an application programming interface, the external reference data comprising at least one of economic indicator data, meteorological data, and market data; and
generate the inference data based on both the feature vector and the external reference data.

16. The system according to claim 1, wherein the circuitry is further configured to:
receive feedback data from the client terminal via the packet-switched network;
perform sentiment analysis on the feedback data by inputting the feedback data into a natural language processing model; and
retrain the data generation model based on a result of the sentiment analysis.

17. The system according to claim 1, wherein the circuitry is further configured to generate support data by inputting the inference data and user attribute data into a recommendation engine, the support data identifying resources associated with executing a recommendation indicated by the inference data.

18. A system comprising:
a communication interface configured to communicate with a client terminal via a packet-switched network;
a processor;
a random-access memory;
a memory storing a data generation model comprising a generative artificial intelligence model trained by deep learning on a neural network, and an emotion identification model comprising a multimodal neural network; and
a database;
circuitry configured to:
acquire input data from a plurality of data sources via the communication interface, the input data comprising text data, numerical data, and image data;
generate a multidimensional input tensor by preprocessing the input data, the preprocessing comprising tokenization of the text data, normalization of the numerical data, and resizing of the image data;
extract a feature vector from the multidimensional input tensor by inputting the multidimensional input tensor into a trained neural network comprising a Transformer-based model, a convolutional neural network, and a gradient boosting decision tree;
generate inference data by inputting the feature vector into the data generation model;
store the inference data in the database;
acquire multimodal sensor data from the client terminal via the communication interface, the multimodal sensor data comprising image data, audio waveform data, and text data;
compute an emotion value by inputting the multimodal sensor data into the emotion identification model, the emotion identification model comprising a convolutional neural network for processing the image data, a recurrent neural network for processing the audio waveform data, and a large language model for processing the text data;
select an output mode from among a detailed output mode, a concise output mode, and a visual output mode based on the emotion value; and
transmit the inference data to the client terminal via the communication interface in accordance with the selected output mode.

19. The system according to claim 18, wherein the circuitry is further configured to retrieve time-series records of prior data acquisitions from the database and select an optimal data acquisition method by inputting the time-series records into a long short-term memory network.

20. A method performed by circuitry of a system, the method comprising:
acquiring input data from a plurality of data sources via a packet-switched network;
generating a multidimensional input tensor by preprocessing the input data, the preprocessing comprising tokenization of text data and normalization of numerical data;
extracting a feature vector from the multidimensional input tensor by inputting the multidimensional input tensor into a trained neural network comprising a Transformer-based model and a convolutional neural network;
generating inference data by inputting the feature vector into a data generation model stored in a memory of the system, the data generation model comprising a generative artificial intelligence model trained by deep learning on a neural network; and
transmitting the inference data to a client terminal via the packet-switched network.
